(19) United States
(12) Patent Application Publication
(10) Pub. No.: US 2010/0059996 A1
(43) Pub. Date: Mar. 11, 2010

(54) TUBE COMPRESSION FITTING AND FLARED FITTING USED WITH CONNECTION BODY AND METHOD OF MAKING SAME

(76) Inventors: Samuel D. Ciprich, Erie, PA (US); Matthew T. Bernosky, Linesville, PA (US)

Correspondence Address: WOODLING, KROST AND RUST, 9213 CHILLICOTHE ROAD, KIRTLAND, OH, 44094, US

(21) Appl. No.: 12/205,840

(22) Filed: Sep. 5, 2008

(51) Int. Cl. F16L 19/05; B23P 17/00

(52) U.S. Cl. 285/342; 29/890.14

(57) ABSTRACT

A high pressure tube compression fitting/flared fitting for use in combination with a thick-walled tube and a connection body wherein a sleeve is in engagement with a thick-walled tube. The sleeve is generally cylindrically shaped with the exterior thereof coated and then etched. The sleeve includes a sharp annular biting portion engaging the thick walled tube. The sleeve further includes an inner annular symmetric concavity which engages the thick-walled tube upon deformation thereof. The thick-walled tube includes a flared end portion. A gland about the thick-walled tube engages the sleeve forcing it into engagement with the frusto-conical portion of the connection body coupling the tube, tube fitting and connection body together. The flared end of the thick-walled tube interengages and seals the frusto-conical portion of the connection body. A process for making the device includes the step of placing the thick-walled tube into engagement with the frusto-conical portion of a die to flare the end portion of the thick-walled tube.

### FIELD OF THE INVENTION

The invention relates to a tube coupling for connecting a tube to a connection body.

### BACKGROUND OF THE INVENTION

FIG. 1 is an enlarged side view 100 of a tube coupling disclosed in prior art U.S. Pat. No. 2,850,202 to M. F. Bauer. FIG. 2 is an enlarged and fragmentary cross-sectional view 200 of the forward end portion of the sleeve 13 shown in the prior art device illustrated in FIG. 1. FIG. 3 is a modified form 300 of the forward end portion of the sleeve 13 illustrated in the prior art device illustrated in FIG. 2. FIG. 4 is a fragmentary side view 400 of the wedge insert 20 illustrating the knurled outer surface 23 portion. FIG. 5 is a fragmentary side view 500 taken along the lines 4-4 of FIG. 2 showing principally the knurled section 23.

U.S. Pat. No. 2,850,303 to M. F. Bauer, entitled Double Sealed Compression Fitting, recites, at col. 3, lns. 54 et seq. with reference to FIG. 1 thereof, “that the invention comprises generally a coupling or connection body 11, a coupling nut 12, and a contractible sleeve 13 adapted to contractibly engage a tube 10. The coupling body 11 is provided at its right-hand end with male threads 14, which are adapted to be threadably engaged by female threads 15 provided in the nut 12 for pressing the sleeve into engagement with the tube. The male threads 14 and the female threads 15 constitute connection means for drawing the connecting body 11 and the coupling nut 12 toward each other. As illustrated, the connection body 11 is provided with a laterally extending outer wall or an entrance end portion 16 with substantially a conical opening 45 extending into said body from said outer wall 16. The conical opening 45 receives the sleeve 13 and the end of the tube 10 and has an internal annular cam surface 17 with a first end portion 46 disposed adjacent the outer wall 16 and a second end portion 47 within the body member disposed longitudinally remote from the outer wall 16. The first end portion 46 has a maximum diameter and the second end portion 47 has a minimum diameter. The internal annular cam surface 17 slopes radially inwardly in substantially a straight line from the first end portion 46 to the second end portion 47 and defines an acute angle with respect to the longitudinal axis of the tube. Extending longitudinally beyond the inwardly converging cam surface 17 is a socket or counter bore 18 which is provided with a terminating end surface 19. The inwardly converging cam surface 17 may be preferably about nine degrees and preferably may lie in a range of approximately eight to twelve degrees, but may be in a wider range of approximately seven to twenty degrees, measured with respect to the longitudinal axis of the tube.

Mounted in the socket 18 is a wedge insert 20 having an abutting end surface 21 and an annular wedge wall or a flare end surface 22. In assembly, the insert 20 is pressed into the socket 18 until the abutting end surface 21 abuts against the terminating end surface 19 for making a sealing engagement therebetween. In order to resist longitudinal movement of the insert 20 out of the socket 18, there is provided a knurled portion 23 which provides longitudinal spaced ribs therearound to-make an interlocking engagement with the wall of the counter bore or socket 18. As the wedge insert 20 is pressed or driven into the counter bore or socket 18, the smooth or unknurled forward portion acts as a guide and elevated ribs of the knurled portion 23 cut or make their own longitudinal grooves into the wall of the socket or counter bore 18 so that the wedge insert becomes a permanent part of the connection body 11. The terminating end surface 19 of the socket 18 is disposed at a reverse slope of approximately five degrees so that when the abutting end surface 21 of the wedge insert is pressed against the terminating end surface 19 a good fluid seal is made therebetween at substantially the bore of the connection body 11. While I preferably use a knurled section to hold the insert 20 in the socket 18, it is understood that any other suitable means may be employed for this purpose.

When my coupling is used for joining steel tubing to a connection body, I preferably construct the wedge insert 20 of steel which is capable of being quench hardenable throughout its entire mass and thereafter tempered or drawn back to a hardness value greater than that of the tube. I find that steel known as 4140, heat treated throughout its entire mass and tempered to a hardness value of approximately 30 to 45 Rockwell, is satisfactory for my insert. When my coupling is used with copper tubing, the insert is preferably constructed of hard brass so that the insert has a hardness value greater than that of the copper tubing. When my coupling is used with stainless steel tubing the wedge insert may be made of hardenable stainless steel. As illustrated, in the drawing, the flare end surface 22 of the insert 20 terminates at its pointed end in a rounded nose 24. It is to be noted that the outwardly converging cam surface 17 and the annular wedge wall or flare end surface 22 define sides of a substantially triangular space comprising a converging annular walled chamber. The annular wedge wall 22 defines in conjunction with the opening 45 an annular converging space 48 pointing away from the outer wall 16 to receive the end of the tube which extends beyond the contractible end portion of the sleeve 13. The annular wedge wall 22 has first end region 49 having a minimum diameter to fit inside the tube and has a second end region 50 with a maximum diameter upon which the end of the tube slides as it is being flared. The annular wedge wall 22 slopes radially outwardly in substantially a straight line from the first end region 49 to the second end region 50 and has an acute angle with respect to the longitudinal axis of the tube. The internal annular cam surface 17 and the and wedge wall 22 are angularly disposed with respect to each other and define an acute angle therebetween. The second end portion 7 of the internal annular cam surface 17 and the second end region 50 of the annular wedge wall 22 converge toward each other, and they have surfaces with a radial distance therebetween less than the wall thickness of the tube to wedgingly receive the end of the tube. The internal annular cam surface 17 has an intermediate portion 51 between the first and second end portions 46 and 47. The intermediate end portion 51 is longitudinally coextensive with and surrounds the first end region 49 of the annular wedge wall 22.

The sleeve 13 has a bore 31 adapted to surround the tube and comprises a continuous annular body 25 provided with rearwardly extending segmental fingers 20 which grip the tube when the nut is tightened. When my coupling is used with steel tubing, this sleeve is preferably constructed of steel which is capable of being quench-hardenable throughout its entire mass and thereafter tempered or drawn back to a hardness value greater than that of the tube. I find that steel known as 4140, heat-treated throughout its entire mass and tempered to a hardness value of approximately 30 to 45 Rockwell, is satisfactory for my sleeve. When my coupling is used with copper tubing, the sleeve is preferably constructed of hard brass so that the insert has a hardness value greater than that of the copper tubing. When my coupling is used with stainless steel tubing the sleeve may be made of hardenable stainless steel.

In the manufacturing of the sleeve, the fingers 26 are provided by making slots 27 in the rearward section thereof at annularly spaced intervals thereabout. In FIG. 1, four slots are used, but any number may be used. The continuous annular body 25 has a leading or forward contractible end portion 28 and a rearward end portion 29. As illustrated, the end portion 29 constitutes the forward terminus for the slots 27. The leading or forward contractible end portion 28 has at its forward end a cam surface 30 which engages the inwardly converging camming surface 17 of the connection body 11. The inside surface of the leading or forward contractible end portion 28 of the sleeve is preferably provided with a major rib 32 which is longitudinally spaced from the end of the sleeve. The inside diameter of the rib 32 is preferably about the same diameter as the bore 31 of the sleeve. In order to provide for making the rib, the inside surface of the forward end portion of the sleeve is recessed at an angle preferably about five degrees, thereby making the recess wall 34. The depth of the major rib 32 may be in the neighborhood of 0.012 inch. The rib 32 is provided with forward edge 35 which constitutes a biting edge for biting into the tube.

The forward edge 35 constitutes laterally extending circumferential walls terminating in circumferential cutting edge to bite and make its own grooves into the outside surface of the tube. The forward edge 35 of the rib 32 faces the annular wedge wall 22. The radial distance between the first end region 49 of the annular wedge wall and the intermediate portion 51 of the internal annular cam surface 17 is less than the lateral wall thickness of the tube plus the lateral thickness of the sleeve between the outer cam surface 30 and the circumferential cutting edge of the rib 32. The outer cam surface 30 prior to assembly has a diameter less than the maximum diameter of the first end portion 46 of the internal annular cam surface 17 and greater than the minimum diameter of the second end portion 47 of the internal annular cam surface 17 and initially contacts the internal annular cam surface 17 between the first end portion 46 and the intermediate portion 51.

The portion of the sleeve in advance of the major rib 32 constitutes an auxiliary body or shell 37. This shell functions to support the outside wall of the tub in advance of the major rib 32. The intermediate part of the entire sleeve, that is, the rearward end of the continuous annular body 25 and the forward end of the segmental fingers 26 is enlarged to provide a tapered or cam shoulder 38 against which a cam shoulder 39 of the nut engages for pressing the contractible sleeve into the inwardly converging cam surface 17 of the connection body 11. The tightening of the nut against the cam shoulder 38 of the sleeve contracts the segmental fingers about the tube for supporting the tube against vibration. It is to be noted that the cam shoulder 39 on the nut oppositely faces the converging cam surface 17 and the terminating end surface 19 of the socket, as well as the flare end surface 22 of the insert.

In assembly, as the sleeve is pressed forward by the tightening of the nut, the outer annular cam surface 30 of the sleeve forceably engages the inwardly converging cam surface 17 of the connection body and thereby produces a camming action which cams or deflects the leading or forward contractible end portion 28 of the sleeve against the tube. The camming action embeds the rib 32 into the tube. The rib 32 makes its own groove in the outer surface of the tube so that as the nut is further tightened, the end of the tube is forced into the triangular space with the inner surface of the tube riding upwardly upon the annular wedge wall or flare end surface 22 of the insert for self-flaring the end of the tube in advance of the major rib 32.

From the above description, it is noted that the coupling during the initial stages of the assembly operates as a no-flare fitting, whereby the outside and inside walls of the sleeve make fluid sealing engagement respectively with the converging cam surface 17 of the connection body and the outside surface of the tube. As the nut is further tightened during the final stages of the assembly of the coupling, the inside surface of the tube rides up upon the annular wedge wall or flare end surface 22 for flaring the tube, whereby another seal is effected between the tube and the insert 20. In other words, during the final stage of assembly, the flare end of the tube is pressed between the sleeve and the annular wedge wall or flare end surface 22 of the insert 20. The force of the end of the tube against the annular wedge wall or flare end surface 22 forces the entire insert into the socket 18, whereby the abutting end surface 21 of the insert makes good fluid seal engagement with the terminating end surface 19 of the connection body.

The circumferential cutting edge of the rib 32 cuts its own grooves into the outside surface of the tube with the laterally extending circumferential wall 35 pressing against the side wall of the groove. The laterally extending circumferential side wall 35 of the rib and the side wall of the groove against which it presses provide a driving engagement between the tube 10 and the sleeve 13 thereby carrying the tube along with the sleeve forcing the inside surface of the end of the tube with a wedging movement against the annular wedge wall 22 to flare the end of the tube in advance of the circumferential cutting edge 35 of the rib 32. The flaring of the end of the tube permits the sleeve 13 and the tube 10 carried there along to move farther into the conical opening 45, for pressing the end of the tube wedgingly into the converging space between the second end portion 47 of the internal annular cam surface 17 and the second end region 50 of the annular wedge wall 22 with the outside surface of the tube making wedging contact against the second end portion 47 of the internal annular cam surface 11 and the inside surface of the tube making a wedging contact with the second end region 50 of the annular wedge wall 22. These wedging contacts limit the movement of the tube into the converging space between the second end portion 47 of the internal annular cam surface 17 and the second end region 50 of the annular wedge. The flaring of the end of the tube also permits the sleeve 13 and the tube 10 carried there along to move farther into the conical opening 45 for pressing the tube and the contractible end portion 28 of the sleeve wedgingly into the converging space between the first end region 49 of the annular wedge wall 22 and the intermediate portion 51 of the internal annular cam surface 17 with the outer surface on the sleeve making a wedging engagement against the intermediate portion 51 of the internal annular cam surface 17 and with the inside surface of the tube making a wedging engagement with the first end region 49 of the annular wedge wall 22. These first and second wedging engagements in combination with the driving engagement between the laterally extending circumferential wall and the side wall of the groove against which it presses arrest the movement of the sleeve 13 into the converging space between the intermediate portion 51 of the internal annular cam surface 17 and the first end region 49 of the annular wedge wall 22. The circumferential cutting edge of the rib 32 upon final assembly of the tube is laterally spaced from the first end region 49 of the annular wedge wall 22 for a distance which is less than the lateral distance of the wall thickness of the tube.

During the final stages of assembly, the shell 37 functions as a preformed chip, filling substantially all the small triangular space between the outside surface of the tube and the inwardlly converging cam surface 17, with the result that there is no more space into which loose metal from the tube in advance of the major rib 32 may flow when an extraordinarily heavy force is applied to the tightening of the nut. The wall thickness of the shell 37 may be 0.010 inch to 0.020 inch and the length thereof may be preferably about 1/32 inch or slightly longer. In actual observation, with a coupling cut in section, the small triangular space is substantially undiscernible, because the metal under pressure tends to flow somewhat to make the triangular space in actual construction smaller than it appears upon the drawing, which does not take into account the flow of the metal under pressure. Inasmuch as the annular wedge wall or end surface 22 supports the end of the tube, the coupling may be assembled and disassembled in an unlimited number of times because upon each assembly, the joined parts produce a “rock-bottom,” “hit-home” feeling to the nut, since there is no substantial space into which the metal which is under sealing pressure may flow.

FIG. 2 shows the parts in the assembled condition with the view enlarged. In FIG. 3, Bauer illustrates a modified form of the leading or forward end portion of the sleeve in that the ribs have been replaced by a forward biting edge or shoulder 40 which bites into the tube for making a sealing engagement therewith. The action of the forward biting edge 40 after it makes its own groove into the tube is substantially the same as that for the ribs. The shell 41 is also provided in advance of the forward biting edge 40 in order to support the metal of the tube in advance of the biting edge, as well as to substantially seal the small triangular space between the outside surface of the tube and the inwardly converging cam surface 17 of the connection. The assembly of the coupling with the modified sleeve in FIG. 3 is the same as that for the sleeve shown in FIG. 1 and 2. From the foregoing description, it is noted that the Bauer coupling claims to be a combination of both the flare and the no flare types of couplings, and thus obtain the advantages of each while overcoming their disadvantages. Bauer claims to avoid the necessity for flaring the tube in advance of assembly of the coupling as would be necessary with a flare fitting. Further, Bauer claims that his invention overcomes the disadvantage of the no flare fitting in that it obtains a “rock-bottom,”0 “hit-home” feeling when tightening the nut during repeated assembly of the fitting.

In FIGS. 1, 2, and 3 of the drawing, the wall thickness of the tubing is approximately 0.049 inch. With my assembled coupling cut in section and under actual observation, the end of the tube would have a small triangular space 48 in advance thereof. The FIGS. 6 and 7 show the use of my coupling with tubing having a wall thickness of approximately 0.035 inches. Here the triangular space 48 in advance of the end of the tube is somewhat smaller than it is in FIGS. 1, 2, and 3. The FIGS. 8 and 9 show the use of my coupling with tubing having a wall thickness of approximately 0.065 inch. In this instance, the triangular space 48 in advance of the end of the tube is somewhat larger than it is in FIGS. 1, 2, and 3.

My tube coupling accommodates tubing having a wide range of wall thicknesses. One aspect of the invention is that regardless of the wall thickness of the tubing, the distance between the forward end of the tube and the forward end of the sleeve bears about the same relation to each other in the assembled fitting. One would ordinarily conclude that this relationship could not be, and it is difficult to explain the reason therefor. Regardless of the explanation, it is to be pointed out that the rib 32 or the biting edge 40 of the sleeve makes a driving connection between the sleeve and the tube. This driving connection forces the forward end of the tube against the flared wedge wall 22 and thereby self-flares the end of the tube. At the same time, the forward end of the tube is coined or pressed into the triangular space 48. As the forward end of the tube is pressed into the triangular space 48, the outside surface of the forward end of the tube is coined between 47 and 50 and possibly extruding the wedged end of the tube therebetween with the result the end of the tube becomes tapered and elongated. In actual practice, the outer surface of the tube at the forward end thereof at 47 becomes tapered and burnished as the nut is tightened, providing a first perfect sealing area between both sides of the tube against the minimum spaced wall portions 47 and 50.

In the final assembly of the tubing, the minimum spaced wall portions between 47 and 50 arrest the forward movement of the tube therebetween, into the triangular space 48. One novelty of the connection is that the forward end of the tube is arrested in its forward movement between the minimum spaced wall portions 47 and 50, while the sleeve and tube as a unit is arrested in its forward movement between the maximum spaced wall portions 51 and 49, providing a second perfect sealing area. It is to be noted that the invention has a first perfect sealing area for the tube alone between 47 and 50 and a second perfect sealing area for the tube and sleeve as a unit between 51 and 49. These two perfect sealing areas are longitudinally spaced apart and both sealing areas reside between tapered wedging surfaces, namely, the cam wall 17 and the wedge wall 22. Ordinarily when an attempt is made to match machine tolerances to obtain two perfect sealing areas at two longitudinally spaced tapered regions, such as shown in this invention, difficulty arises from the inability to match such tolerances. Both areas do not effect their seal simultaneously. Usually one area “hit-home” or seals before the other. In this invention, the matching of tolerances is accomplished automatically and constitutes one of the unexpected results of my invention. The problem of matching tolerances becomes all the more complex when it is realized that my fitting accommodates tubing having varying tube wall thicknesses. One explanation for the automatic accommodation of matching tolerances arises from two facts: (1) that the coining of the end of the tube at 47 allows the end of tube to wedgingly move forward into triangular space 48, and (2) that probably with tubing of different wall thicknesses, the rib 32 or the biting edge 40 may variably skid or move longitudinally with respect to the tube so that a first perfect seal is made at the end of the tube between 47 and 50 simultaneously with the making of a second perfect seal for the sleeve and tube as a unit between 51 and 49.”

The Bauer patent design is double sealing making: (1) a first perfect seal at the end of the tube between: (a) the second end region 50 of the internal annular cam/wedge wall 22 of the insert 20 and the tube 10, and, (b) the region 47 of the internal cam 17 of the connection body and the tube 10; and, simultaneously (2) making of a second perfect seal for the sleeve 13 and tube 10 as a unit between: (a) intermediate portion 51 of the internal annular cam 17 of the connection body 11 and the sleeve/tube combination, and, (b) the first end region 49 of the annular wedge wall/cam 22 of the insert 20 and the sleeve/tube combination. The Bauer patent discloses a triangular apex 33 meeting at a point and it is this apex into which the sleeve/tube combination is driven. Also disclosed in the Bauer patent is a bore 42 through the insert 20.

The Bauer connection is assembled in a single step with flaring taking place at assembly. The Bauer patent design is vague in describing what tubing materials that it can be used with. Its tubing materials are described as copper, steel, stainless steel. The instant invention is for use primarily with cold worked 300 series stainless steel which is much harder than the tubing the Bauer design uses. The Bauer patent design mentions tubing wall thicknesses of 0.035 to 0.065, the majority of tubing sizes used with the instant invention have a wall thickness greater than 0.065. The Bauer the '303 patent does not mention any surface hardening of the sleeve. It is apparent when viewing FIGS. 1, 2, 3, 6, 7, 8 and 9 of the '303 patent to Bauer is that sleeve 13 is long and includes a long continuous annular body 25 provided with rearwardly extending fingers. It is also apparent from Bauer that sleeve 13 and, in particular, annular body 25 buckles upon loading when nut 12 is torqued as can be seen by the gap between the tube body and the sleeve. Therefore, the “hit home” feeling may not be achieved upon over torquing the nut 12 thus limiting the load that can be applied to the sleeve 13 by the nut 12.

FIG. 6 is a cross-sectional view 600 of prior art U.S. Pat. No. 3,970,336 to O'Sickey for a tube coupling joint. FIG. 6 illustrated herein is substantially the same as FIG. 1 of the '336 patent to O'Sickey. Referring to FIG. 6, bore 611 and bore 612 are illustrated in the joint. Transverse shoulder 613 abuts body 610. Body 610 includes a cam surface 615 which engages radially contractible portion 624 of sleeve 622 as coupling nut 638 is threaded 639 to body 610. Tube 617 includes outer portion 618. Tube 617 may be a relatively thick walled tube and is engaged by radially contractible portion 624 of sleeve 622 which forms a transverse shoulder 620. Enlarged portion 625 includes a tapered shoulder 642 driven by a corresponding surface of coupling nut 638.

U.S. Pat. No. 3,970,336 uses two processes. The first process creates a compression fitting/flared fitting using a hydraulic tool. The compression fitting/flare fitting is then removed and tightened by hand in its connection for final assembly. The O'Sickey '336 patent uses a cylindrically flared tube. The instant invention, among other things, uses a tapered flare. The O'Sickey '336 patent is for use with heavy wall tubing but it does not mention what material the tubing is made of or the pressure it will be used at in service. The O'Sickey patent design does not specify any materials, hardening or surface hardening of any of the components used for flaring, or connection makeup. The O'Sickey patent design seals in two places. One seal point is where the sleeve contacts the tubing and the other seal point is where the sleeve contacts the body. Sleeve 622 in O'Sickey contacts process fluid.

FIG. 6A is a cross-sectional view 600A of a prior art design. FIG. 6B is an enlargement 600B of a portion of FIG. 6A. Autoclave Engineers Fluid Components Division uses a fitting illustrated in FIGS. 6A and 6B for cold-worked stainless steel tubing 655 which includes a sleeve 654 wherein only a mechanical bite 658 is cut into the tubing. Housing 651, die 650, gland 652, and threads 653 between housing and gland are illustrated in FIG. 6A. The design illustrated in FIGS. 6A and 6B includes a sleeve 654 which acts like a cutting tool shaving material from the tubing wall. Annular hook-shaped peel 656 is illustrated in FIGS. 6A and 6B as is the tip portion 657 of the peel. Interengagement 659 of sleeve 654 and tubing 655 as well as the sleeve lip of sleeve extension 660 are illustrated in FIGS. 6A and 6B. Reference numeral 661 illustrates the gap between the sleeve extension 660, tube 655 and annular hook-shaped peel 656. Reference numeral 661 represents the gap between the sleeve extension 660, tube 655 and annular hook-shaped peel 656. No flare is used in the compression fitting of FIGS. 6A and 6B.

### SUMMARY OF THE INVENTION

A tube fitting for use in combination with a thick-walled tube and a connection body wherein a sleeve is in engagement with a thick-walled tube. The sleeve is generally cylindrically shaped with the exterior thereof etched. The sleeve includes a sharp annular biting portion engaging the thick walled tube. The sleeve further includes an inner annular symmetric concavity which engages the thick-walled tube upon deformation thereof. The thick-walled tube includes a flared end portion. A gland about the thick-walled tube engages the sleeve forcing it into engagement with the frusto-conical portion of the connection body coupling the tube, tube fitting and connection body together. The flared end of the thick-walled tube interengages and seals the frusto-conical portion of the connection body. A process for making the device includes the step of placing the thick-walled tube into engagement with the frusto-conical portion of a die to flare the end portion of the thick-walled tube.

The sleeve includes an end portion having an extended lip portion and wherein the thick-walled tube includes a bulbous portion engaging the extended lip portion of the sleeve. The sleeve interengages the thick-walled tube near the end portion of the thick-walled tube. The extended lip portion forms a cavity in the sleeve. The thick-walled tube includes a bulbous portion engaging the extended lip portion of the sleeve. The exterior of the sleeve includes first and second tapered surfaces.

The sleeve has a longitudinal axis and the extended lip portion includes a recess (cavity). The recess (cavity) includes first and second legs and the first leg is substantially parallel to the longitudinal axis and the second leg is substantially transverse to the first leg. The first and second legs form an angle less than 90°.

The tube fitting is also usable in combination with a thick-walled tube and a connection body. A gland about the thick-walled tube is engageable with the sleeve. The gland includes exterior threads thereon which are matingly threaded into a connection body which includes a frusto-conical portion. The exterior threads of the gland interengage the interior threads of the connection body, coupling the tube, the tube fitting and the connection body together. The flared end of the thick-walled tube interengages and seals against the frusto-conical portion of the connection body. The connection body further includes an exterior and a leak detection passageway extending to the exterior of the connection body.

The process for making a tube fitting for use in combination with a thick-walled tube includes the steps of: placing a thick-walled tube into engagement with the frusto-conical portion of a die such that the inner diameter of the tube interengages the tube engaging surface of the frusto-conical portion of the die, the die being supported by a driving piston; sliding a sleeve over the tube, the sleeve includes an interior and an exterior, the exterior of the sleeve having a coating thereover and then being chemically etched with, for instance, an appropriate acid, the sleeve includes a sharp annular biting portion engaging the thick-walled tube, the sleeve includes an interior annular symmetric concavity, the concavity of the sleeve interengaging the thick-walled tube; securing the sleeve into forceful engagement with the die; driving the die into the thick-walled tube and the sleeve with the driving piston; flaring the end portion of the thick-walled tube; and, deforming the sleeve into engagement with the thick-walled tube. The sliding sleeve has a longitudinal axis and the extended lip portion includes a recess (cavity). The recess includes first and second legs and the first leg being substantially parallel to the longitudinal axis and the second leg being substantially transverse to the first leg. The step of driving the die into the thick-walled tube includes forcing and engaging the sharp annular biting portion with the thick-walled tube includes deforming (extruding) the tube into engagement with the recess (cavity) in the extended lip.

The invention includes a forming operation and deforms (extrudes) the tubing material into the desired shape and requires a high force to flare the tubing wall. The invention employs a sleeve wherein the wall thickness of the sleeve is relatively thick and the overall length is relatively short to increase resistance of the sleeve to buckling. The angle formed between the non-biting end of the sleeve and the gland is 30 degrees instead of some designs employing 45 degrees from horizontal to eliminate deformation of the gland material outward from the axis of the flared joint. The invention uses both a mechanical bite (compression fitting) and a flared tube end (flared fitting).

Creation of the tubing bite (compression fitting) and flared end (flared fitting) are performed in a single operation before assembly in the connection body. Once the compression fitting/tube flaring operation has been completed then the final assembly is accomplished wherein the fitting is interconnected with a connection body.

In the creation of the fitting, the die is forced upward by a hydraulic cylinder toward the cap which is held in place with a threaded interconnection in the housing. The die engages the sleeve on a taper which in turn causes the sleeve to engage the gland on a taper. As the die continues to move upwardly the sleeve is prevented from collapsing outwardly as the gland supports the sleeve and is held in place by the cap. Initially, and before the die begins moving upwardly, the tubing rests on the tube engaging surface of the frusto-conical portion of the die and is slidably moveable within the sleeve and the gland against the force of gravity and can be moved freely upwardly.

As the die is moved upwardly, the sleeve is compressed against the gland by the die. The sleeve includes an extended lip portion (overhanging nose) with a radius that prevents the hardened surface of the sleeve (i.e. coated with an XADC-Armoloy® coating from damaging the tapered surface of the die.) XADC-Armoloy® is a trademark of Armoloy Corporation. Use of XADC-Armoloy® creates a hardened surface while maintaining sufficient lubricity. Before the die begins its upward movement under the force of the hydraulic screw piston, a cavity exists between the extended lip portion of the sleeve and the tube. The tapered exterior surfaces of the sleeve are deformed to substantially match the sleeve engaging tapered inner wall surface of the die. At the same time the biting edge of the sleeve begins to penetrate tube surface forcing the inside corner of the tube against the sleeve engaging taper of the frusto-conically shaped portion of the die. A relief in the sleeve and use of the XADC-Armoloy® coating on the exterior surface of the sleeve (which increases the surface hardness of the sleeve) in combination ensures that the annular biting edge of the sleeve penetrates the tube.

As the die continues to move upwardly toward the cap, the taper of the sleeve engaging surface of the die forces the annular biting edge of the sleeve into the tube deforming the tube material prohibiting movement of the tubing upwardly and simultaneously causes the annular inside corner of the tube end to be deformed and flared outwardly.

When the die comes into contact with the cap, material from the tube has filled the extended lip portion and the cavity defined by extended lip portion sleeve end and the tube end is flared out to a greater diameter than the inside of the sleeve. The pressure is then vented from the hydraulic cylinder, and the gland, sleeve and tube are removed by unthreading the gland from the cap. The flared tube end is now ready for final assembly into its matching connection opening.

The flare connection assembly includes the steps of inserting the tube and sleeve into the connection opening. Then the gland is threaded in and tightened by hand. The bottom of the connection opening has a surfaces formed in frusto-conical shape which seal on the inside of the tubing flare. The angle of the flared tube end and the frusto-conical shape are dissimilar so the seal starts as an annular surface contact on the frusto-conically shaped protrusion at the base of the housing of the connection. When the gland is torqued the sleeve contacts the inward taper in the connection body causing the sleeve to grip the tube which helps the fitting resist vibration and applies a force to the deformed (raised) tubing material as the bite increases the load carried through the tube to the frusto-conically shaped protrusion at the base of the connection. This deforms the material of the tube as required to achieve the metal to metal seal. The surface of the gland has a coating to reduce friction and permit the torque required for the seal to be applied. Further torquing of the gland applies additional force to the sleeve, the tube and may increase flaring of the tube.

The structure of the compression fitting/flare fitting includes inherent safety features which allow the person assembling the device to determine if the sleeve does not effectively bite into the tube correctly. Specifically, the end of the tube will not flare correctly giving a visual indication that the process to form the fitting was unsuccessful. With most high pressure compression fittings it was not possible to make visual inspection to know if the mechanical bite was made correctly, the only way to know if the fitting was made correctly was to test it through use. In addition, were the bite to fail, the flared tube end of the invention would not be able to pass through the sleeve thus preventing ejection of the tubing. Tube ejection is a common failure mode of incorrectly assembled compression fittings and has the potential to cause serious injury.

If the flare does not seal correctly there is a bleed hole or passageway so pressure cannot build up around the sleeve or connection threads and cause a possible failure resulting in part ejection. This also allows for a visual indication that a connection is leaking.

Preferred materials of construction include: (1) the tubing is made of cold worked 300 series stainless steel; (2) gland is made of cold worked 316 stainless steel coated with baked on Molykote® (molybdenum disulfide), a registered trademark of Dow Corning Corporation; (3) cap is made of alloy steel; (4) the sleeve is made of through hardened Inconel 718 stainless steel (Rockwell hardness 36) (other steel alloys may be used) with XADC-Armoloy® Coating (Rockwell hardness 93) or TDC-Armoloy® Coating (78 Rockwell hardness); (5) the die is made of hardened steel; (6) the housing is made of aluminum; and, (7) a hydraulic cylinder. When the flared tubing engages the frusto-conical portion of the connection body a seal is formed and the sleeve remains dry (not in contact with the process fluid). In view thereof, the sleeve may be made of many different alloys. Further, the gland may be coated with other lubricants.

### BRIEF DESCRIPTION OF THE DRAWINGS

FIG. 1 is an enlarged side view of a tube coupling of prior art U.S. Pat. No. 2,850,202 to M. F. Bauer.

FIG. 2 is an enlarged and fragmentary cross-sectional view of the forward end portion of the sleeve shown in the prior art device illustrated in FIG. 1.

FIG. 3 is a modified form of the forward end portion of the sleeve illustrated in the prior art device illustrated in FIG. 2.

FIG. 4 is a fragmentary side view of the wedge insert illustrating the knurled outer surface portion.

FIG. 5 is a fragmentary side view taken along the lines 4-4 of FIG. 2 showing principally the knurled section.

FIG. 6 is a cross-sectional view of prior art U.S. Pat. No. 3,970,336 to O'Sickey.

FIG. 6A is a cross-sectional view of a prior art design.

FIG. 6B is an enlargement of a portion of FIG. 6A.

FIG. 7 is an exploded view of the apparatus for making the fitting.

FIG. 7A is a top view of the die.

FIG. 7B is a cross-sectional view of the die taken along the lines 7B-7B.

FIG. 7C is an enlarged cross-sectional view of the sleeve.

FIG. 7D is an exaggerated cross-sectional schematic view of a portion of the sleeve illustrating details of construction including the coating.

FIG. 7E is an enlargement of a portion of FIG. 7D.

FIG. 8 is a cross-sectional view of the apparatus for forming the fitting assembled.

FIG. 9 is an enlarged portion of FIG. 8 illustrating the die in a first position.

FIG. 9A is an enlarged portion of FIG. 9.

FIG. 10 is a view similar to FIG. 9 with the die in a second position.

FIG. 10A is an enlarged portion of FIG. 10.

FIG. 11 is a view similar to FIG. 10 with the die in a third position.

FIG. 11A is an enlarged portion of FIG. 11.

FIG. 12 is a view similar to FIG. 11 with the die in fourth position abutting the cap.

FIG. 12A is an enlarged portion of FIG. 12.

FIG. 13 is a view similar to FIG. 12 with the die in the process of being extracted away from the cap.

FIG. 14 is a front view of the fitting after assembly.

FIG. 14A is a cross-sectional view of the fitting of FIG. 14 taken along the lines 14A-14A.

FIG. 14B is a front view of the connection body.

FIG. 14C is cross-sectional view of the connection body taken along the lines 14C-14C of FIG. 14.

FIG. 14D is an enlarged cross-sectional view of the fitting secured to the connection body.

FIG. 14 E is an enlarged cross-sectional view of the fitting secured to the connection body wherein the connection body includes a flow path.

FIG. 15 is a schematic of the process for making the fitting.

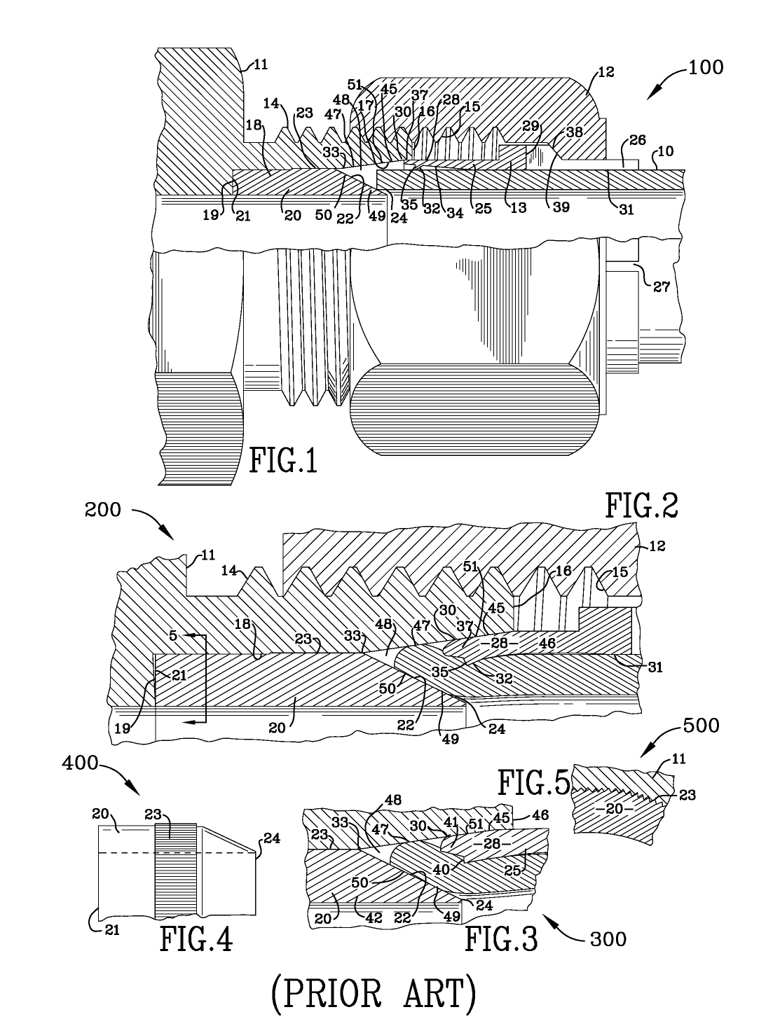

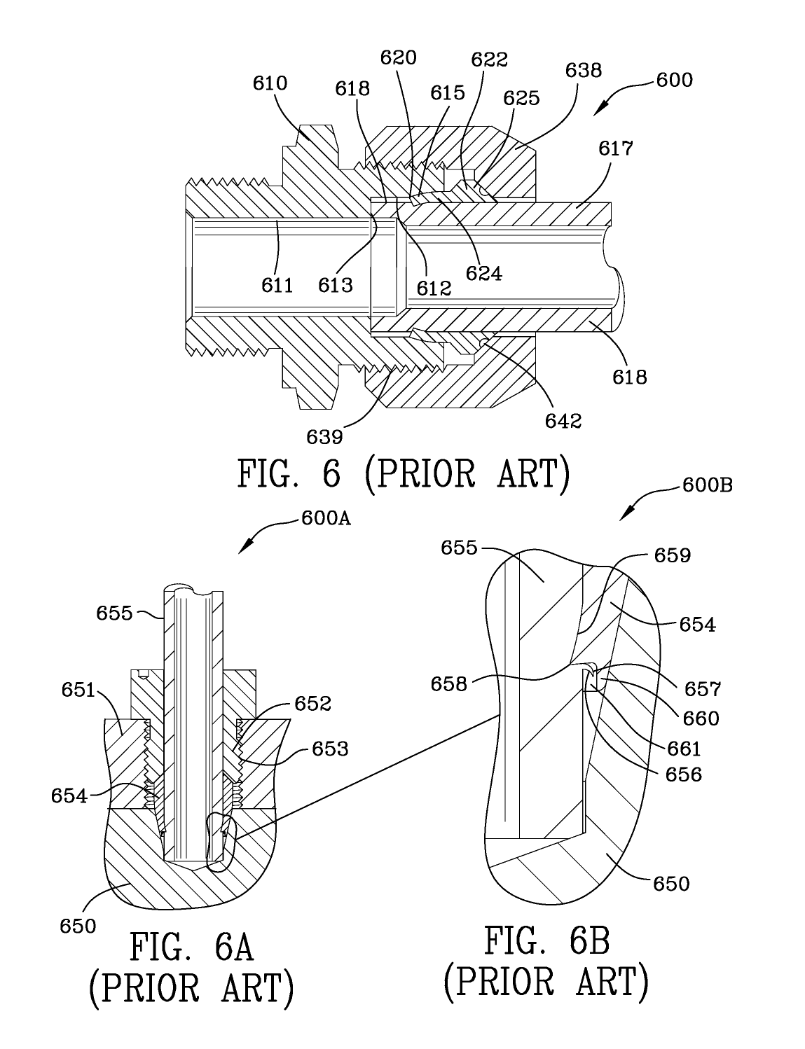

### DESCRIPTION OF THE INVENTION

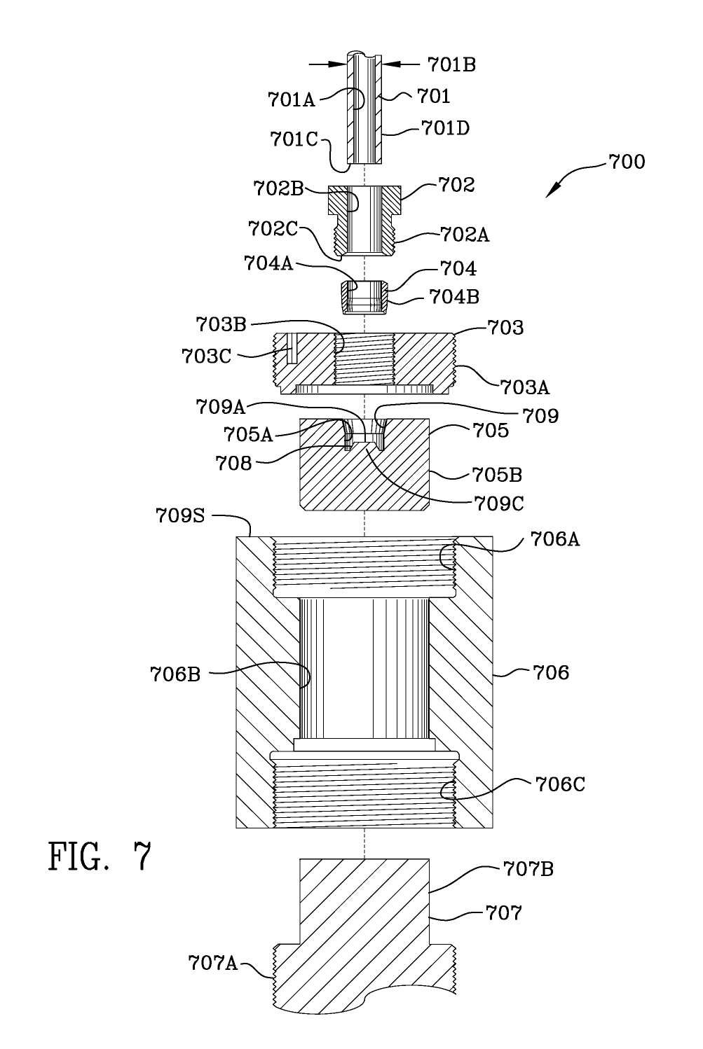

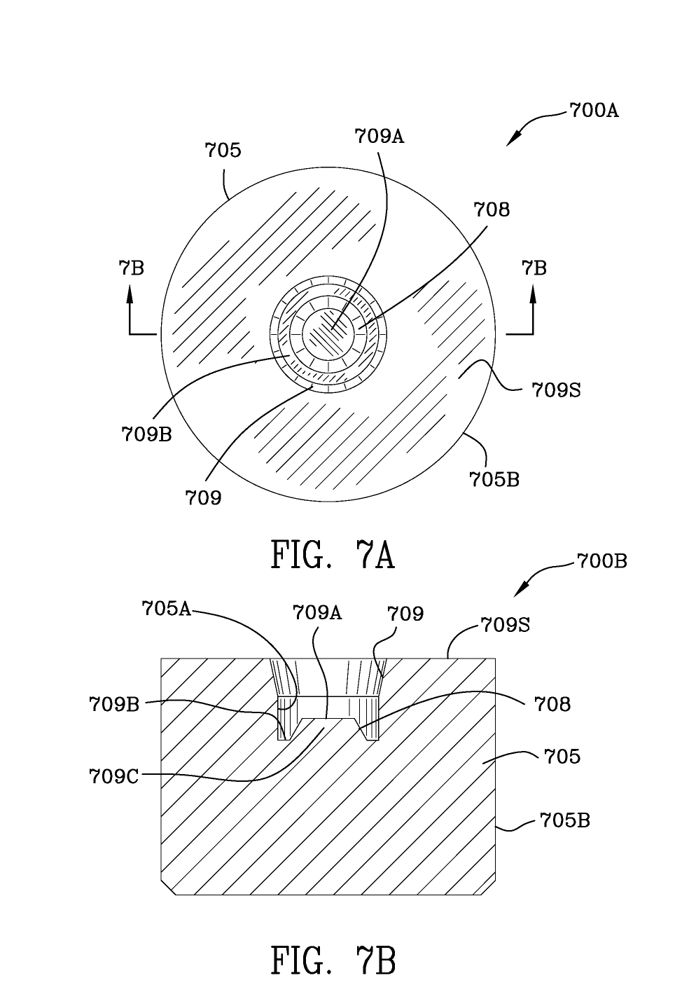

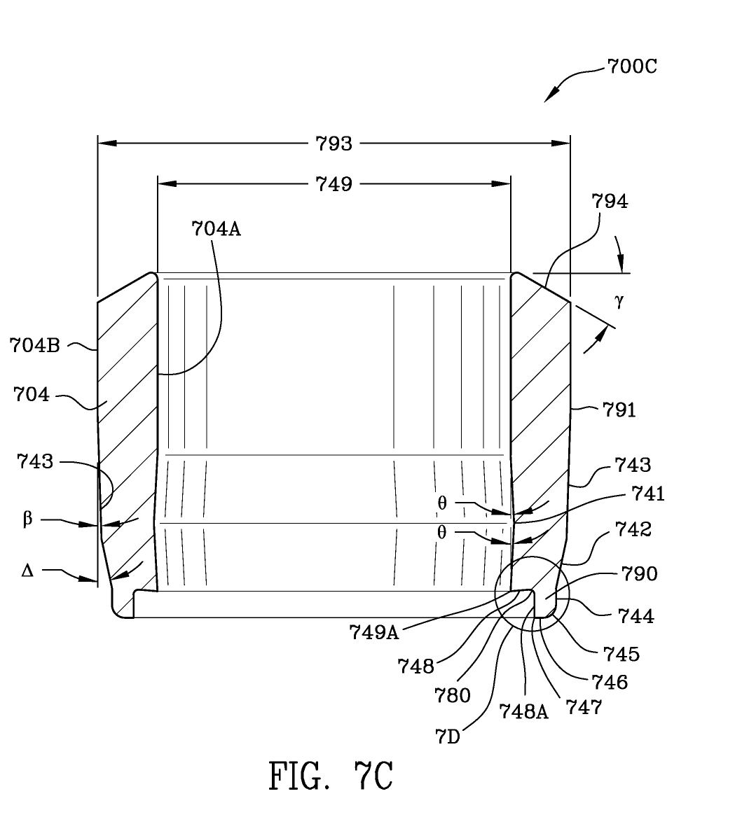

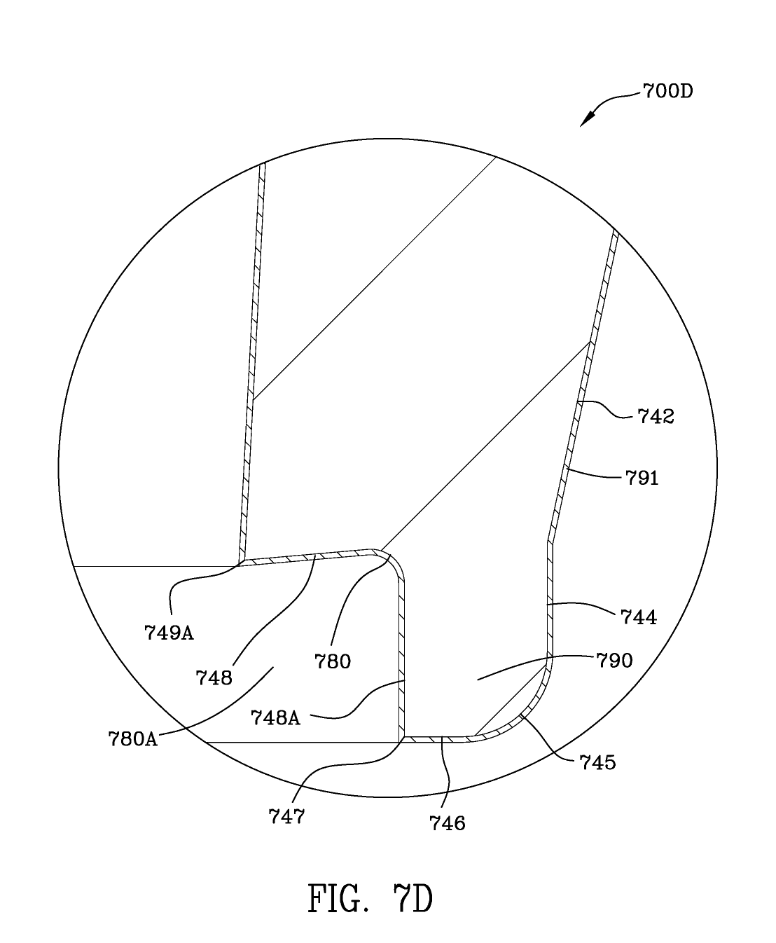

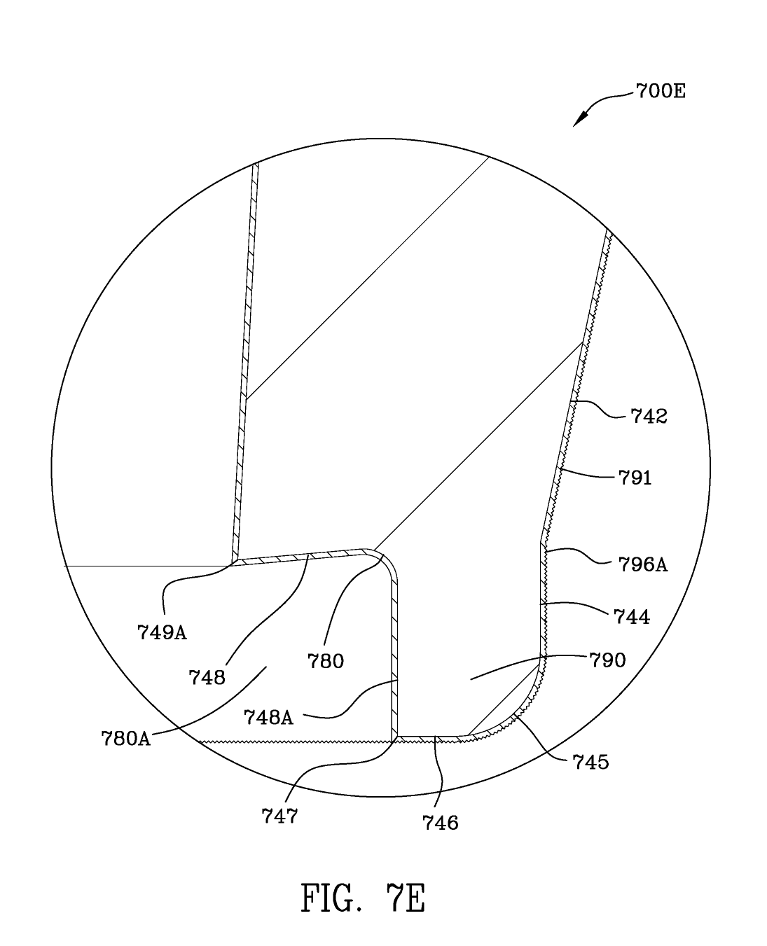

FIG. 7 is an exploded view 700 of the apparatus for making the fitting illustrating: thick walled tubing 701, interior of the tubing 701A, exterior of the tubing 701D, width of the tubing 701B and the end of tubing 701C. Gland 702 includes exterior threads on gland 702A. Gland 702 includes an inner cylindrically shaped passageway 702B through which thick walled tubing 701 passes. Cap 703 includes exterior threads 703A which mate with interior threads 706A in the aluminum housing 706. Cap 703 is rotated with a rod (not shown) inserted into cap 703. Cap 703 further includes an annular recess into which the die 705 enters. Sleeve 704 includes an inner contoured surface 704A which is generally cylindrically shaped with a relief which facilitates bending and deforming the sleeve with pressure and force applied by the gland 702 as described hereinbelow. Die 705 includes a contoured interior 705A which includes a sleeve engaging tapered surface 709 which interengages the exterior 704B of the sleeve 704. Contoured interior 705A includes a sleeve engaging tapered inner wall 709 and a tube engaging tapered wall surface 708 of frusto-conically shaped flaring protrusion 709C.

Still referring to FIG. 7, die 705 includes a cylindrically shaped exterior surface 705B sized to slidably engage cylindrical passageway 706B of housing 706. Die 705 is somewhat analogous to a piston within a piston cylinder and movable therewith. Housing 706 includes a second set of internal threads 706C therein. Screwed hydraulic cylinder 707 includes a driving portion of the cylinder which slidingly engages the inner cylindrical passageway 706B of the aluminum housing 706. Exterior threads 707A on the screwed hydraulic cylinder 707 interengage interior threads 706C of the housing. A drive mechanism, which may be hydraulically or electrically driven, rotates piston 707.

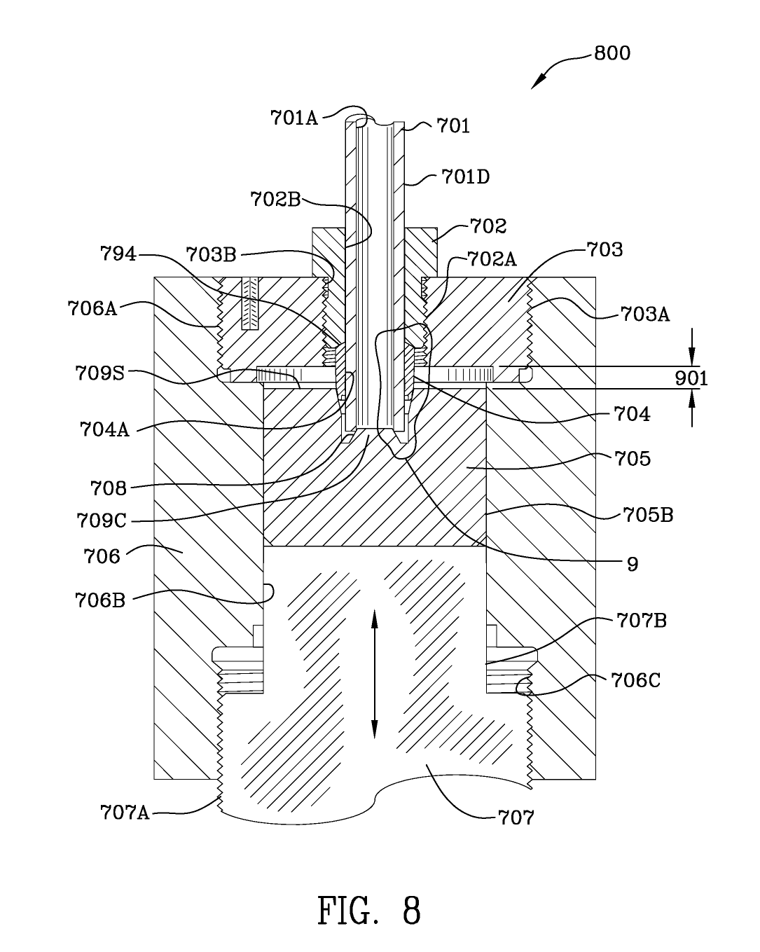

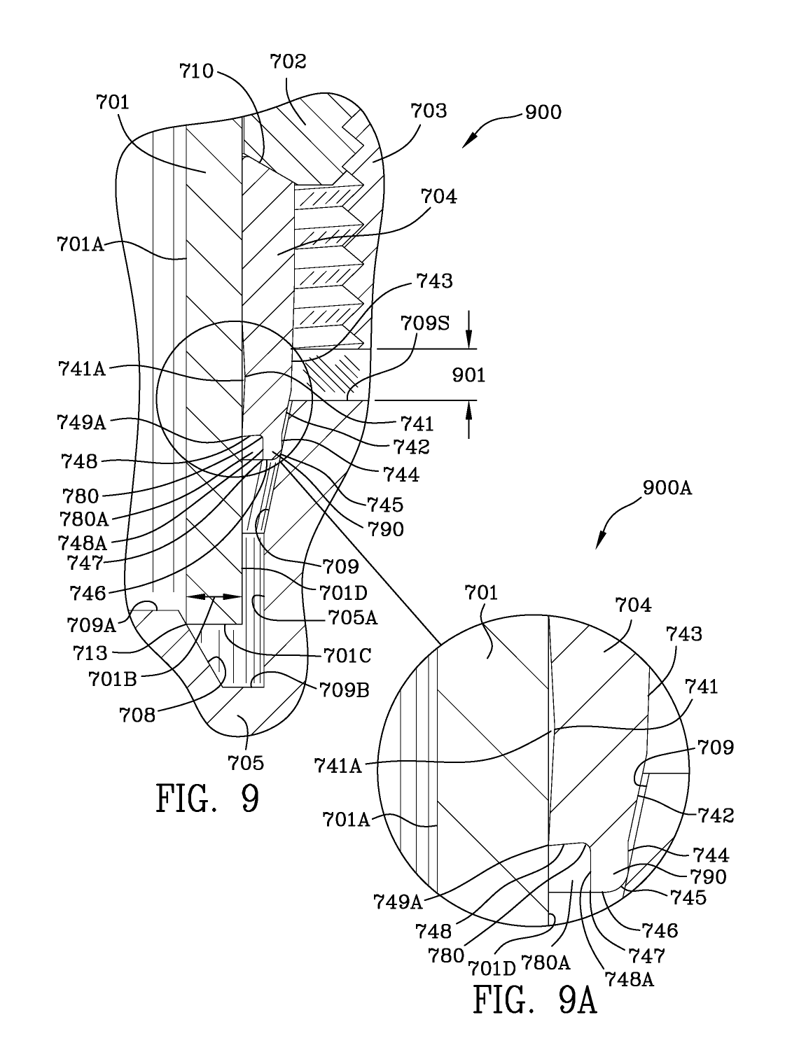

Still referring to FIG. 7, plateau 709A of the frusto-concially shaped flaring protrusion 709C resides as described hereinbelow within the inner diameter of thick-walled tubing 701 as illustrated in FIGS. 8 and 9. FIG. 8 is a cross-sectional view 800 of the apparatus for forming the fitting assembled. FIG. 9 is an enlarged portion 900 of FIG. 8 illustrating the die 705 in a first position before the die begins moving upwardly under the force of the screw type hydraulic cylinder. Gap 901 is illustrated in FIG. 9 and represents the spacing between the die 705 and the cap 703. It will be noticed in FIG. 9 that the inner wall 701A of the thick walled tube 701 includes an inside of the end portion 713 of the tube in engagement with the tube engaging tapered wall surface 708 of frusto-conically shaped flaring cone/protrusion 709C. As illustrated in FIG. 9 tube 701 sits in engagement with surface 708 of the frusto-conically shaped flaring cone/protrusion 709C without any force other than gravity applied thereto. FIGS. 8 and 9 illustrate the flat bottom inner portion of die 709B and the plateau 709A of the frusto-conically shaped flaring cone 709C of the die 705.

FIG. 7A is a top view 700A of the die and FIG. 7B is a cross-sectional view 700B of the die taken along the lines 7B-7B. Upper surface 709A of die 705 is illustrated in FIGS. 7A and 7B and this surface engages cap 703 when the die is driven upwardly. Referring to FIGS. 8 and 9, reference numeral 710 represents the interengagement between gland 702 and sleeve 704.

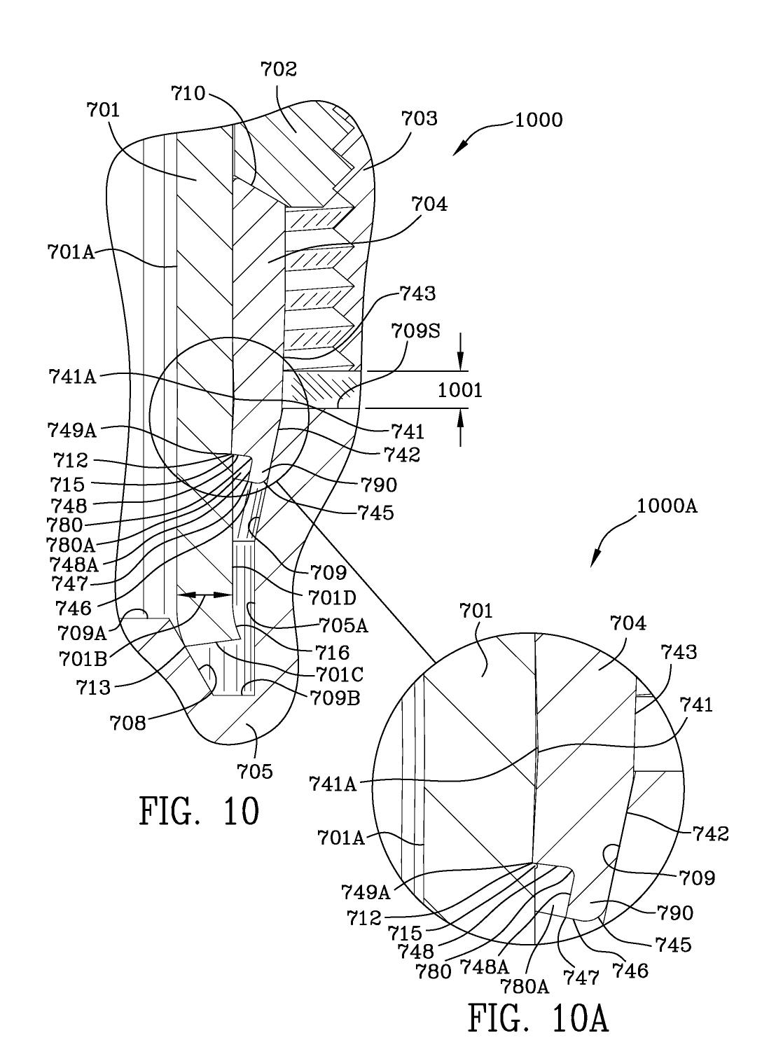

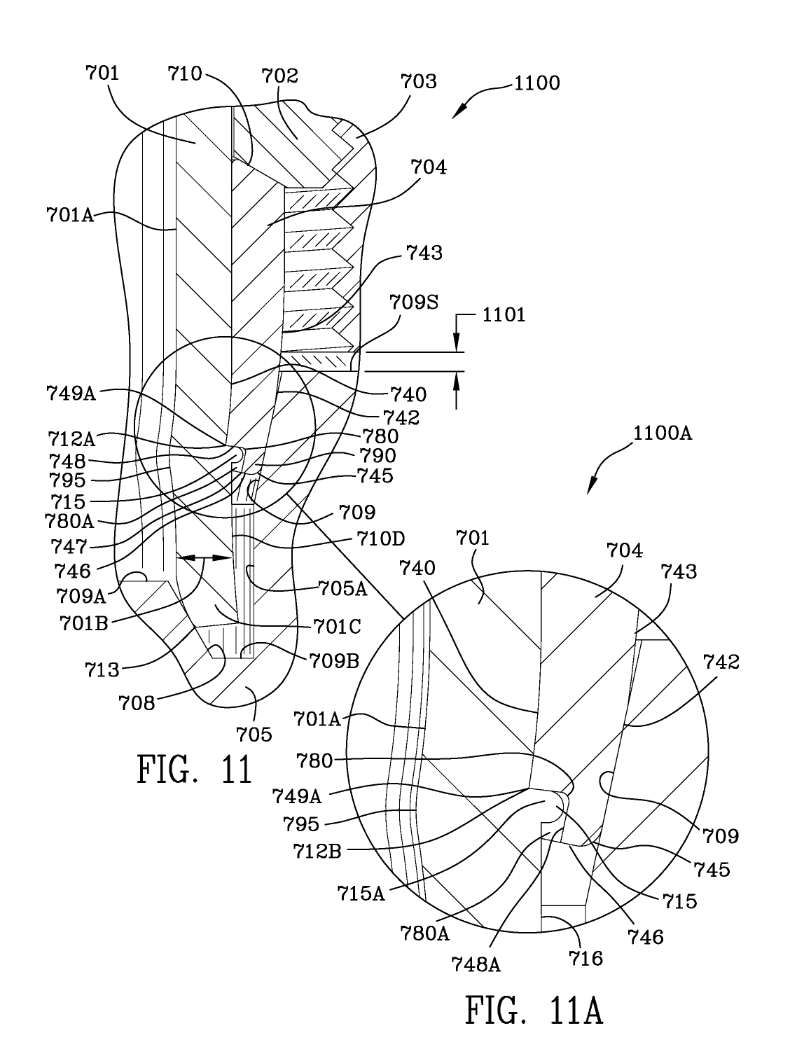

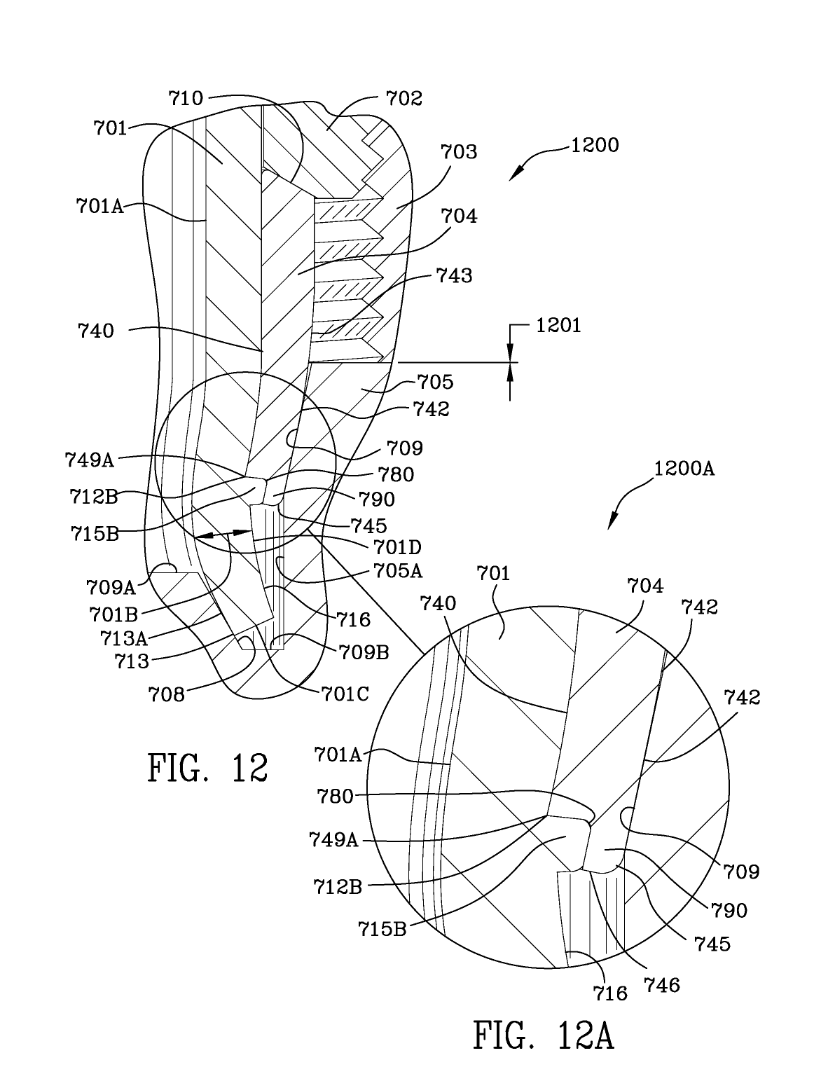

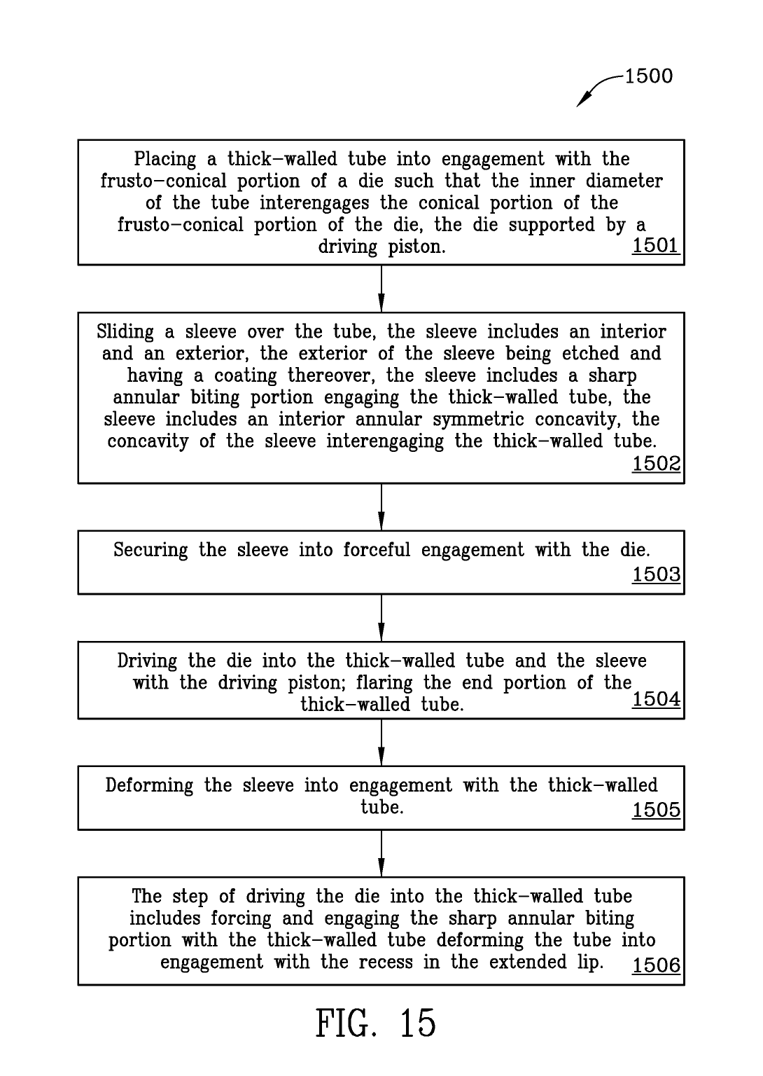

FIG. 15 is a schematic 1500 of the process for making the fitting in combination with a thick-walled tube 701. The process includes placing a thick-walled tube 701 into engagement with the tube engaging tapered wall surface 708 of frusto-conically shaped flaring cone 709C such that the inner diameter 701A, 713 of the tube interengages the surface 708 of the frusto-conical portion of the die. The die, as previously stated, is supported by a driving cylinder 707 and is driven thereby. Next, the process includes sliding the sleeve 704 over the thick-walled tube 701 wherein the sleeve includes an interior and an exterior. The exterior of the sleeve is etched and has an XADC-Armoloy® coating thereover. The sleeve 704 includes a sharp annular biting portion engaging the thick-walled tube. The sleeve 704 includes an interior annular symmetric concavity and the concavity of the sleeve interengages the thick-walled tube. Next, the step of securing the sleeve into forceful engagement with the die is performed by raising or lifting the die. The step of driving the die into the thick-walled tube and the sleeve with the driving piston is performed simultaneously flaring the end portion of the thick-walled tube. Simultaneously the step of deforming the sleeve into engagement with the thick-walled tube 1505 is performed. The step of driving the die into the thick-walled tube includes forcing and engaging the sharp annular biting portion with the thick-walled tube deforming the tube into engagement with the recess in the extended lip. The driving cylinder raises the die in a continuous motion toward the cap and into engagement therewith. FIGS. 9-12 illustrate the die in different positions with respect to the stationary cap. FIG. 9 represents the position of the die before it is moved upwardly and FIG. 12 represents the position of the die when it has been moved fully upwardly and engages the cap. FIGS. 10 and 11 represent intermediate positions between the extremes illustrated in FIGS. 9 and 12.

FIG. 7C is an enlarged cross-sectional view 700C of the sleeve. By way of example, nominally the sleeve 704 has an inner diameter 749 of approximately 0.560 inches and an outer diameter 793 of 0.750 inches. The approximate length of sleeve 704 is 0.548 inches. FIG. 7D is a schematic, exaggerated and enlarged cross-sectional schematic view 700D of a portion of the sleeve illustrating details of construction including the XADC Aramaloy coating 791. By exaggerated it is meant that the coating is actually only 0.0003 to 0.0006 inches thick and would not be seen if drawn to scale, therefore, the thickness of the coating is exaggerated relative to its actual size so that it may be seen. In FIG. 7D the coating 791 is drawn to be approximately 3 times actual scale. FIG. 7E is an enlargement 700E of a portion of FIG. 7D.

Reference numeral 741 defines an inner concavity in the sleeve 704. The angle θ defines the concavity or relief 741 and measures about 3°. Inner concavity or relief 741 is symmetric as viewed in FIG. 7C. Generally the interior or inner surface 704A of the sleeve is cylindrically shaped and includes the relief 741 just described. Sleeve 704 is includes an XADC-Armoloy® coating 791 thereover which includes synthetic nanodiamonds particles having a Rockwell Hardness of 98. Sleeve 704 is chemically etched using an acid. The extended lip portion 790 of the sleeve is also chemically etched as best illustrated in FIG. 7E. FIG. 7E is an enlargement 700E of a portion of FIG. 7D. Reference numeral 796A illustrates a jagged line representative of the chemically etched coating on the exterior surface of the sleeve. Coating 791 generally follows the contour of the sleeve forming an outer surface which is smooth before it is chemically etched forming a rough surface 796A. The wall thickness of the sleeve is nominally 0.095 inches as illustrated in FIG. 7C. The exterior 704B of the sleeve is tapered (first taper 743, second taper 742) as illustrated by angles β (1.787°) and A (12°±1°). Radially curved portion 745 of the sleeve 704 initially engages the die when the sleeve is positioned as shown in FIGS. 8 and 9 (i.e, before die 705 applies upward force on the sleeve and tube). Reference numeral 741A represents the gap between the wall/concavity 741 of the sleeve and the tube 704. Upper beveled edge portion 794 of the sleeve 704 makes a 30° angle γ with respect to the horizontal and interengages a correspondingly angled surface 702C of the gland 702. Surface 702C of the cold worked 316 stainless steel gland is coated with baked on Molykote (molybdenum disulfide) so as to facilitate rotation of the gland with respect to the sleeve 704 when the compression fitting/flare fitting of the instant invention is used with the connection body.

Referring to FIGS. 7C and 7D, the exterior end portion 744, the end of the sleeve 746, edge of the sleeve 747 and the annular sharp biting edge 749A are illustrated. The inner concavity 780 is formed by first 748 and second 748A legs which form an angle of less than 90°. Referring to FIGS. 9-13, reference numeral 780A denotes a space which is progressively filled with metal from the tube as the annular sharp biting edge 749A proceeds deeper into the wall of the tube as the die 705 is forced upwardly.

FIG. 8 is a cross-sectional view 800 of the apparatus which forms the compression fitting/flare fitting. FIG. 8 illustrates the elements of FIG. 7 in the assembled state or condition. Gap 901 between the die and the cap 703 is illustrated and represents the spacing therebetween before the die is urged toward the cap. Gland 702 is illustrated in FIG. 8 as being fully threaded within cap 703 and in engagement with sleeve 704. Gland 702 may be differently sized, for instance, it may have a different length or diameter and it may not bottom out on the cap 703. Many examples of the arrangement of the elements illustrated in FIG. 8 are specifically envisioned. The arrow in FIG. 8 is meant to convey that the piston 707 may be driven in the upward or downward direction.

FIG. 9 is an enlarged portion 900 of FIG. 8 illustrating the die 705 in a first position and before the die begins moving upwardly. FIG. 9A is an enlarged portion 900A of FIG. 9. FIGS. 8, 9 and 9A represent the state of the die, tube and sleeve before upward force is applied by the die/hydraulic piston/cylinder. FIGS. 8 and 9 illustrate the upper surface 709S of the die and a gap 901 is illustrated between the upper surface 709S of the die 705 and the cap 703. FIG. 9A illustrates the legs 748, 748A which together with the thick-walled tube 701 define the cavity 780. Space 780A represents an annular volume which is filled with metal formed by the compression fitting and tube flaring operation. As illustrated in FIG. 9A, initially the annular sharp biting edge 749A is resting in engagement with the outer surface 701D of the tubing and has not yet been forced into cutting and extruding engagement with the tube. The radially curved portion 745 of the exterior surface of the sleeve is illustrated in FIGS. 9 and 9A engaging the sleeve engaging surface 709 of the die 705. The die 705 illustrated in FIGS. 9 is spaced apart from the cap 703 as represented by reference numeral 901.

FIG. 10 is a view 1000 similar to FIG. 9 with the die 705 in a second position. The second position is indicated by gap 1001 which is smaller than the gap 901 revealing that the die 705 has progressed upwardly. FIG. 10 illustrates end 701C of the tube beginning to flare. FIG. 10A is an enlarged portion 1000A of FIG. 10 illustrating the annular sharp biting edge 749A engaging the tube 701 forming an annular cut 712 beginning to form in the exterior surface 701D of the thick-walled tubing and which extrudes metal of the tube into cavity 780 occupying space 780A. As the die 705 is moved upwardly, the sleeve 704 is compressed by the die as the sleeve engaging surface 709 is brought into engagement with the second tapered surface 742 of the exterior of the sleeve. FIGS. 10 and 10A illustrate that the gap 741A illustrated in FIG. 9A is smaller in FIG. 10A as the relief defined by reference numeral 741 is compressed. The sleeve includes an extended lip portion 790 (overhanging nose) with a radius 745 that prevents the hardened surface 701D of the sleeve (i.e. the XADC-Armoloy® coating) from damaging the tapered surface 709 of the die 705. Before the die 705 begins its upward movement under the force of the hydraulic screw piston 707, a cavity 780 exists between the extended lip portion 790 of the sleeve 704 and the tube 701. The first and second tapered exterior surfaces 743, 742 of the sleeve are deformed to substantially match the sleeve engaging tapered inner wall 708 of the die 705. Simultaneously therewith the annular biting edge 749A of the sleeve 704 begins to penetrate the tube surface 701D and begins forcing the annular inside corner 713 of the tube 701 against the respective tube engaging taper surface 708 of the frusto-conically shaped protrusion/cone 709C of the die 705. The relief 741 in sleeve 704 in combination with a hardened annular biting edge 749A of the sleeve 704 (for example, the sleeve with XADC-Armoloy® coating which increases the surface hardness) allows penetration of the tube. As the die 705 continues to move upwardly toward the cap 703, the sleeve engaging tapered inner wall 709 of the die forces the annular biting edge 749A of the sleeve deeper into the tube 701 deforming (extruding) the tube material and simultaneously causes the annular inside corner 713 of the tube end to be deformed and flare outwardly. The relief angle θ in combination with the angle of leg 748 with respect to horizontal as illustrated in FIG. 7C in combination with the XADC-Armoloy® coating provides the ability to cut and extrude the metal of the tube so as to occupy space 780A.

FIG. 11 is a view 1100 similar to FIG. 10 with the die in a third position as indicated by the gap 1101 which is smaller than gap 1001 illustrated in FIG. 10. Gap 1001 reveals that die 705 has progressed upwardly further than in FIGS. 10 and 10A. FIG. 11A is an enlarged portion 1100 of FIG. 11 and illustrates the annular sharp biting edge 749A engaging tube 701 forming a yet deeper annular cut 712A in the exterior surface 701D of the thick-walled tubing 701 as compared to the annular cut 712 of FIGS. 10 and 10A. FIG. 11 illustrates the extrusion of metal from the tube 701 into cavity 780 occupying space 780A. As the die 705 is moved upwardly, sleeve 704 is compressed by the die 705 and the inner surface 701A of the tubing deforms as indicated by an inward bulge 795 as shown in FIGS. 11 and 11A. FIGS. 11 and 11A illustrate that the gap 741A between the exterior tube wall 701D and the concavity 741 of the sleeve illustrated in FIGS. 9A and 10A is nonexistent as the relief/concavity 741 was further compressed and the interior surface 704A of the sleeve 704 and the exterior surface of the thick-walled tube 701D engage as indicated by reference numeral 740.

FIG. 12 is a view 1200 similar to FIG. 11 with the die 705 in fourth and final position abutting and engaging the cap 703. FIG. 12A is an enlarged portion 1200A of FIG. 12. When the die 705 engages cap 703, metal from the tube has been extruded into the cavity 780 and space 780A filling same. Cavity 780 is defined by extended lip portion 790 of the sleeve 704 and the tube 701D. Simultaneously with the extrusion of tube metal to fill concavity 780A as viewed in FIG. 11, tube end 701C is flared out to a diameter larger than the inside diameter of the sleeve 704.

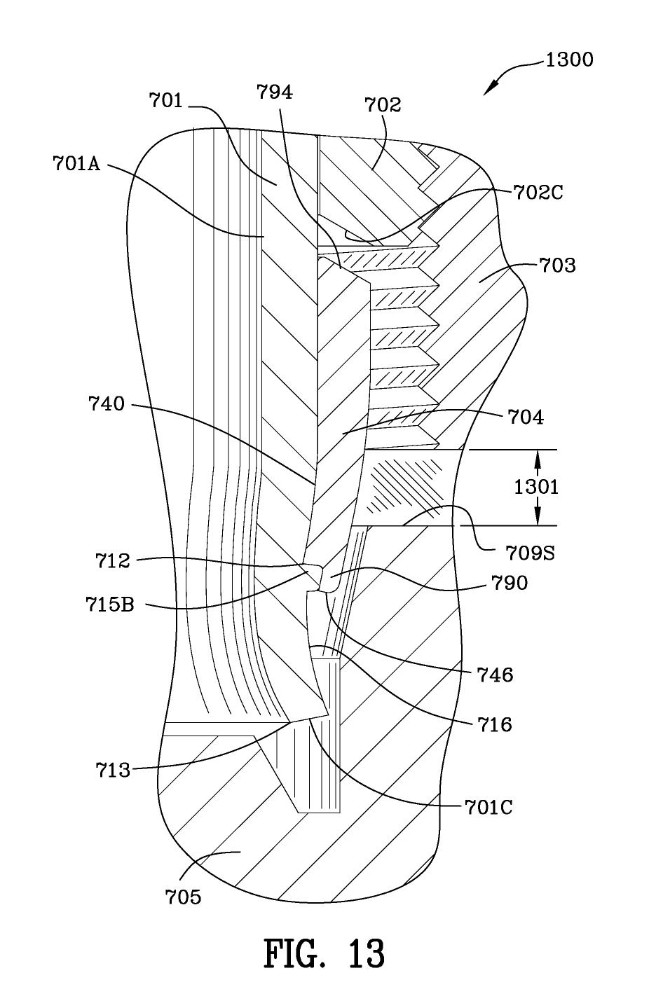

Pressure is then vented from the hydraulic cylinder and then the gland 702, sleeve 704 and tube 701 are removed by unthreading the gland from the cap 703. FIG. 13 is a view 1300 similar to FIG. 12 with the die in the process of being extracted away from the cap as illustrated by gap 1301. As the hydraulic cylinder is vented, the die 705 is withdrawn and the sleeve 704 is separated from the sleeve engaging surface 702C of the gland 702 as illustrated in FIG. 13.

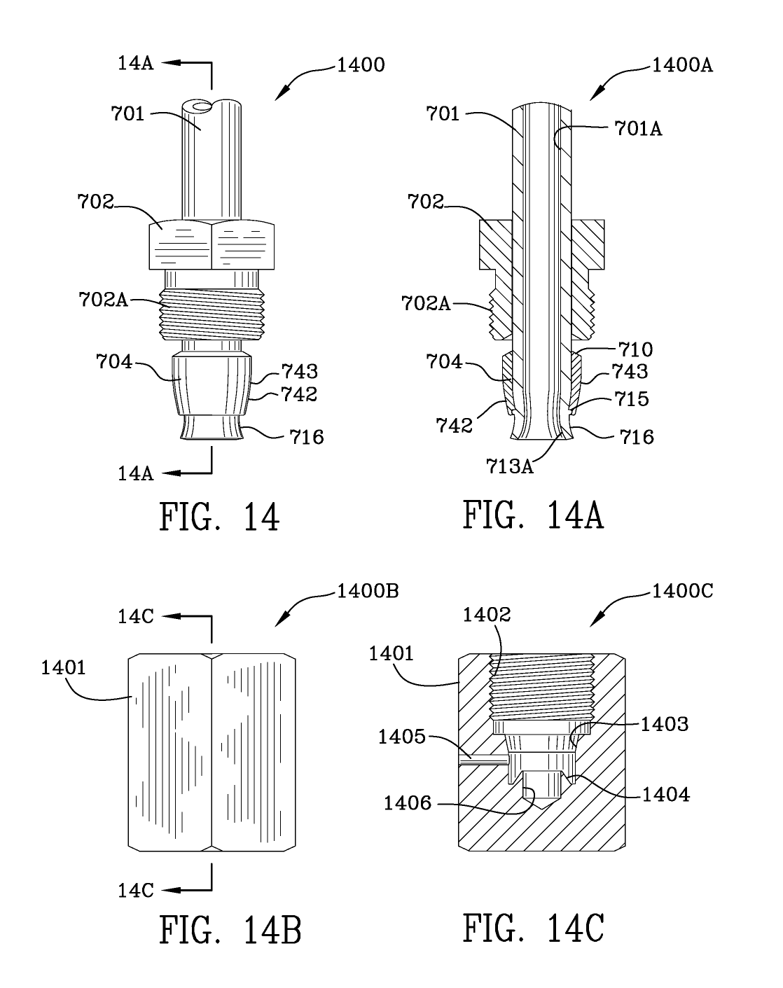

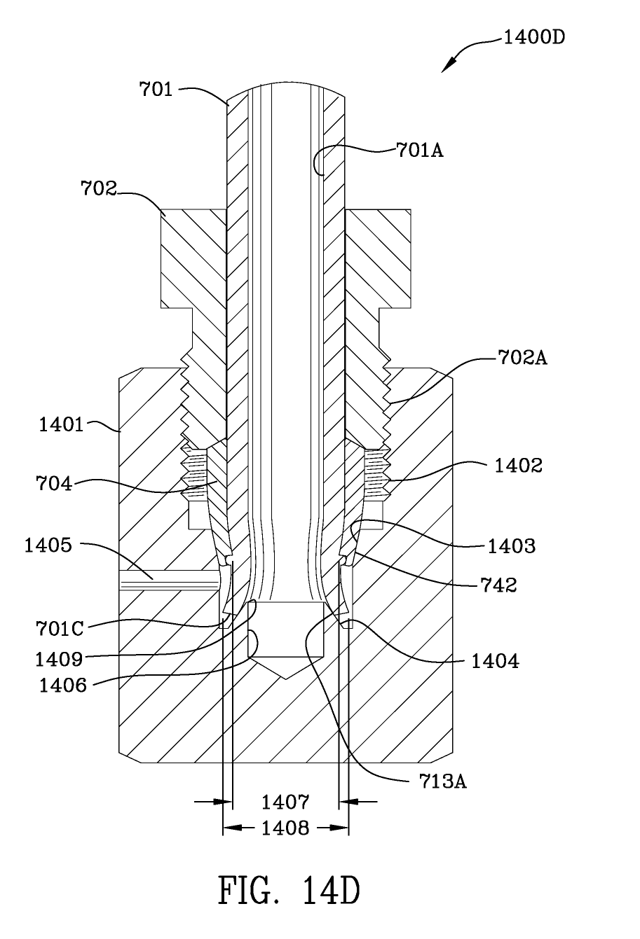

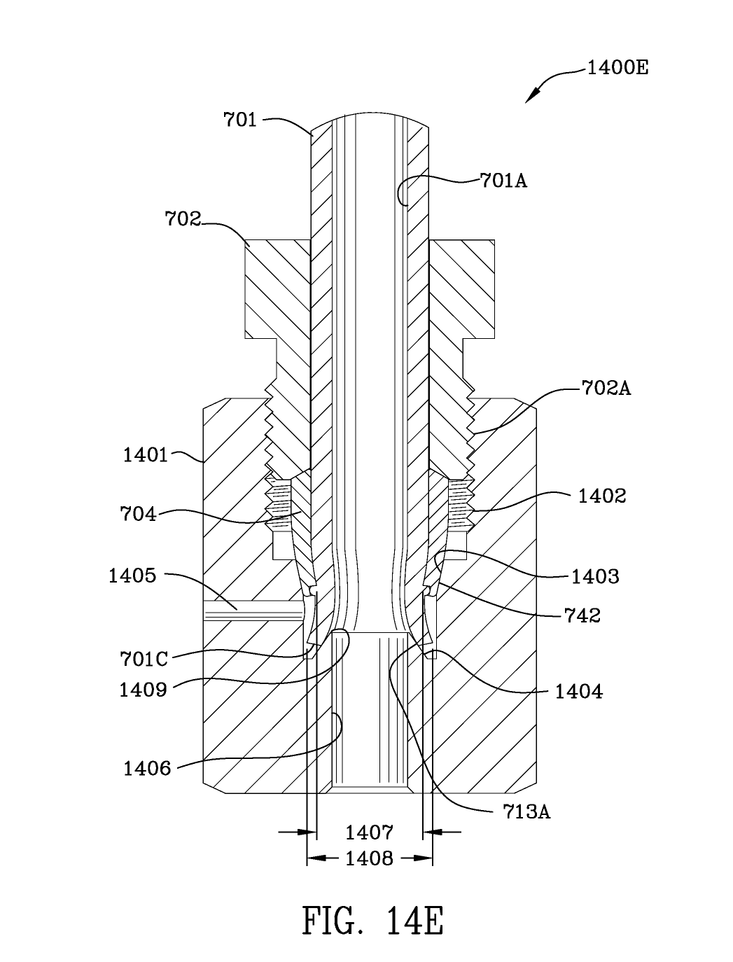

The fitting assembly and flared tube end is now ready for final assembly into its matching connection body as illustrated in FIGS. 14, 14A, 14B, 14C and 14D. FIG. 14 is a front view 1400 of the fitting after it has been completed by the process and apparatus of FIGS. 8-15. FIG. 14A is a cross-sectional view 1400A of the fitting of FIG. 14 taken along the lines 14A-14A and illustrates the gland 702 surrounding the tube 701 with the gland spaced apart from the sleeve 704 for clarity. The person assembling the device can visually inspect the fitting to determine if the sleeve has not engaged the tube correctly by examining the flared end. Since the flaring of the tube end and the compression fitting of the sleeve are integrally related and occur simultaneously, it is not possible to achieve the proper flaring of the tube end if the compression fitting is not formed properly. With most high pressure compression fittings it is not possible to make visual inspections to determine if the mechanical bite was made correctly. The only way to determine if those fittings were made correctly was to test them. In the instant invention, however, were the compressive bite of the sleeve to fail through a fracture of the extruded metal, the flared tube end of the invention would not pass through the sleeve thus preventing ejection of the tubing. Tube ejection is a common failure mode of incorrectly made compression fittings and has the potential to cause serious injury.

FIG. 14B is a front view 1400B of the connection body 1401. FIG. 14C is cross-sectional view 1400C of the connection body taken along the lines 14C-14C of FIG. 14 illustrating internal threads 1402 for mating with external threads 702A of the gland, sleeve engaging surface 1403, and frusto-conical surface of the mating body 1404. The geometry of the engaging surfaces 1403 and 1404 of the connection body may be identical to those of die 705 illustrated in FIGS. 8-13. A bleed port 1405 in connection body 1401 may be used to determine leaks. FIG. 14D is an enlarged cross-sectional view 1400D of the compression fitting/flared tube end combination secured to the connection body 1401 with interengagement of the threads 702A/1402. Since the flared end 701C of the tube has an outside diameter 1408 larger than the inner diameter 1407 of the sleeve as illustrated in FIG. 14D, the tube may not be extracted therefrom. Reference numeral 1406 illustrates the counterbore or flow path of the frusto-conically shaped structure 1409 in the connection body.

If the flare end of the tube does not seal correctly there is a bleed port or passageway 1405 which prevents pressure build up around the sleeve or connection threads and prevents a possible failure resulting in part ejection. Bleed port or passageway 1405 allows for a visual indication that a connection is leaking. Since the sleeve is not normally a wetted part it may be manufactured from materials other than stainless steel.

Preferred materials of construction include: (1) the tubing is made of cold worked 300 series stainless steel; (2) gland is made of cold worked 316 stainless steel coated with baked on Molykote (molybdenum disulfide); (3) cap is made of alloy steel; (4) the sleeve is made of through hardened Inconel 718 stainless steel with XADC-Armoloy® Coating; (5) the die is made of hardened steel; (6) the housing is made of aluminum; (7) a hydraulic cylinder; and, (8) connection bodies are made of cold worked 316 stainless steel.

FIG. 14E is an enlarged cross-sectional view 1400E of the fitting secured to the connection body wherein the connection body includes a flow path 1406.

The invention as described herein is for use with the cold-worked 15,000 psi tubing. At this time use for 20,000 psi or even higher is envisioned. Tubing rated at 15,000 psi is known as thick-walled tubing and has the following dimensions.

15,000 psi tubing (units in inches, nominal)

| Outside | Inside | |
|---|---|---|
| Diameter | Diameter | Wall thickness |
| ¼″ | 0.162″ | 0.043″ |
| ⅜″ | 0.250″ | 0.060″ |
| 9/16″ | 0.359″ | 0.099″ |
| ¾″ | 0.515″ | 0.115″ |
| 1″ | 0.687″ | 0.154″ |

Cold-worked tubing rated at 20,000 psi is also known as thick-walled tubing and has the following dimensions.

20,000 psi tubing (units in inches, nominal)

| Outside | Inside | |
|---|---|---|
| Diameter | Diameter | Wall thickness |
| ¼″ | 0.109″ | .070″ |
| ⅜″ | 0.203″ | .084″ |
| 9/16″ | 0.312″ | .122″ |
| ¾″ | 0.437″ | .154″ |
| 1″ | 0.563″ | .216″ |

For the 9/16″ outside diameter, 15,000 psi rated tubing, approximately 28,000 lbs of force is applied in deforming the sleeve 704 and flaring the tubing. At this load it has been determined that the sleeve 704 does not buckle under the influence of the hydraulic cylinder raising the die up to and against the cap.

### REFERENCE NUMERALS

100—cross-sectional view of prior art patent U.S. Pat. No. 2,850,303
10—tube
11—connection body
12—coupling nut
13—contractible sleeve
14—male threads
15—female threads
16—cam surface
17—annular cam surface
18—socket
19—terminating end surface
20—wedge insert
21—abutting end surface
22—annular wedge wall
23—knurled portion
24—rounded nose
25—continuous annular body
26—segmental fingers
27—slots
28—forward contractible end portion
29—end portion
30—cam surface
31—bore
32—rib
33—triangular apex meeting at a point
34—recess wall
35—laterally extending circumferential wall
37—shell
38—cam shoulder
39—cam shoulder
40—forward biting edge or shoulder
41—shell
42—bore
45—conical opening
46—first end portion
47—region
48—triangular space
49—first end region
50—second end region
51—intermediate portion of the annular cam surface
200—enlarged and fragmentary cross-sectional view of prior art U.S. Pat. No. 2,850,303
300—modified form of prior art U.S. Pat. No. 2,850,303
400—fragmentary side view of the wedge insert
500—fragmentary cross-sectional view along the line 2-2 of 200
600—cross-sectional view of prior art U.S. Pat. No. 3,970,336
600A—cross-sectional view of prior art device
600B—enlargement of a portion of the cross-sectional view of prior art device
610—body
611—bore
612—bore
613—transverse shoulder
615—body cam surface
617—tube
618—outer portion
620—transverse shoulder
622—sleeve
624—radially contractible portion
625—enlarged portion
638—coupling nut
639—threaded interconnection between body 610 and nut 638
642—tapered shoulder
650—square die
651—housing
652—gland
653—threads between housing and gland
654—sleeve
655—tubing
656—annular hook-shaped peel
657—annular tip of hook-shaped peel
658—annular biting edge of sleeve
659—interengagement of sleeve 654 and tubing 655
660—sleeve extension
661—gap between the sleeve extension 660, tube 655 and annular hook-shaped peel
700—exploded assembly view of piston, die, cap, sleeve, gland and tubing
700A—open, upper end view of the die
700B—cross-sectional view of the die taken along the lines 7B-7B
700C—cross-sectional view of an enlarged sleeve
700D—exaggerated cross-sectional view illustrating the coating
700E—enlargement of a portion of FIG. 7D
701—thick walled tubing
701A—inner tubing
701B—width of the tubing
701C—end of tubing
701D—outer surface of the tubing
702—gland
702A—exteriors threads on gland
702B—inner diameter
702C—sleeve engaging surface
703—cap
703A—exterior threads
703B—threads in the cap
703C—aperture enabling cap to be threaded into housing 706
704—sleeve
704A—inner contoured surface of the sleeve
704B—coated exterior of sleeve
705—die
705A—interior of die
705B—exterior of die
706—aluminum housing
706A—interior threads in the housing
706B—internal inner diameter of aluminum housing
706C—second set of internal threads in housing
707—screwed hydraulic cylinder
707A—exterior threads on the screwed hydraulic cylinder
707B—driving portion of cylinder slidingly guided by inner surface 706B of aluminum housing
708—tube engaging tapered wall surface of frusto-conically portion of flaring cone 709C
709—sleeve engaging tapered inner wall of die 705
709A—platueau of the cone
709B—flat bottom inner portion of die
709C—frusto-conically shaped flaring cone 708 of 709C.
709S—upper surface of die 705
710—interengagement between gland and sleeve
712—annular cut in the thick-walled tubing
712A—annular cut in the thick-walled tubing
713—inside of the end portion of the tube
713A—interengagement of the inner portion of the tube and the frusto-conical portion of the flaring cone
715—deformation the annular lip of the tube
715A—increased deformation of the annular lip of the tube
715B—maximum deformation for the annular lip of the tube
716—flared portion of the tube
740—interengagement of the sleeve and the thick-walled tube
741—inner concavity in sleeve 704
741A—gap between the sleeve and the tube
742—tapered outer surface of sleeve 704
743—tapered exterior surface
744—exterior end portion of the sleeve
745—radially curved portion of the sleeve
746—end portion of the sleeve
747—edge
748—first leg
748A—second leg
749—inner diameter of the sleeve
749A—annular sharp biting edge
780—inner concavity of gripping portion
780A—space
790—extended lip portion
791—coated outer surface of sleeve
793—outer diameter of the sleeve
794—upper beveled edge portion of sleeve
795—inward bulge of inner surface 701A
796A—etched outer surface of coating 791
800—cross-sectional view of the piston, die, cap, sleeve, gland and tubing assembled together
900—cross-sectional view of the piston, die, cap, sleeve, gland and tubing assembled together
900A—enlarged cross-sectional view of a portion of FIG. 9
901—gap between cap and piston
1000—cross-sectional view of the piston, die, cap, sleeve, gland and tubing assembled together
1000A—enlarged portion of FIG. 10
1001—reduced gap between cap and piston
1100—cross-sectional view of the piston, die, cap, sleeve, gland and tubing assembled together
1100A—enlarged portion of FIG. 11
1101A—gap during flaring and fitting process
1200—cross-sectional view of the piston, die, cap, sleeve, gland and tubing assembled together
1200A—enlarged portion of FIG. 12
1201—zero gap
1300—cross-sectional view of the piston, die, cap, sleeve, gland and tubing assembled together
1301—gap as the hydraulic cylinder is being withdrawn
1400—front view of the fitting
1400A—cross-sectional view of the fitting
1400B—front view of the housing
1400C—cross-sectional view of the fitting taken along the lines 14C-14C
1400D—cross-sectional view of the fitting engaged with the housing
1401—mating body
1402—threaded interconnection with the fitting
1403—sleeve engaging surface
1404—frusto-conical surface for the mating body
1405—bleed port to determine leaks
1406—counterbore in frusto-conically shaped structure
1407—inner diameter of the sleeve after compression
1408—outside diameter of the tube after flaring
1409—frusto-conically shaped structure 1409 of the connection body
1410—flow path/passageway in the connection body
1500—schematic of the process for making the tube fitting in combination with a thick-walled tube
1501—placing a thick-walled tube into engagement with the frusto-conical portion of a die such that the inner diameter of the tube interengages the conical portion of the frusto-conical portion of the die, the die supported by a driving piston
1502—sliding a sleeve over the tube, the sleeve includes an interior and an exterior, the exterior of the sleeve being etched and having a coating thereover, the sleeve includes a sharp annular biting portion engaging the thick-walled tube, the sleeve includes an interior annular symmetric concavity, the concavity of the sleeve interengaging the thick-walled tube
1503—securing the sleeve into forceful engagement with the die
1504—driving the die into the thick-walled tube and the sleeve with the driving piston; flaring the end portion of the thick-walled tube
1505—deforming the sleeve into engagement with the thick-walled tube.
1506—the step of driving the die into the thick-walled tube includes forcing and engaging the sharp annular biting portion with the thick-walled tube deforming the tube into engagement with the recess in the extended lip
β-angle defining first taper
Δ-angle defining the beveled exterior end portion of the sleeve
θ-angle defining concavity or relief
γ-upper beveled edge portion of sleeve

The invention has been set forth by way of example only. Those skilled in the art will readily recognize that changes may be made to the invention without departing from the spirit and the scope of the claims as set forth hereinbelow.

I claim:

1. A tube fitting for use in combination with a thick-walled tube, comprising:
a sleeve in engagement with said thick-walled tube;
said sleeve being generally cylindrically shaped;
said sleeve includes an interior and an exterior;
said exterior of said sleeve having a coating thereover;
said sleeve includes a sharp annular biting portion engaging said thick walled tube;
said sleeve includes an interior concavity;
said concavity of said sleeve interengaging said thick-walled tube after deformation thereof,
said thick-walled tube includes an end portion; and,
said end portion of said thick walled tube being flared.

2. A tube fitting for use in combination with a thick-walled tube as claimed in claim 1 wherein said sleeve includes an end portion, said end portion of said sleeve includes an extended lip portion and wherein said thick-walled tube includes a bulbous portion engaging said extended lip portion of said sleeve.

3. A tube fitting for use in combination with a thick-walled tube as claimed in claim 2 wherein said sleeve interengages said thick-walled tube near said end portion of said thick-walled tube.

4. A tube fitting for use in combination with a thick-walled tube as claimed in claim 1 wherein said sleeve includes an end portion, said end portion of said sleeve includes an extended lip portion and said extended lip portion forms a cavity in said sleeve, and wherein said thick-walled tube includes a bulbous portion engaging said extended lip portion of said sleeve.

5. A tube fitting for use in combination with a thick-walled tube as claimed in claim 1 wherein said exterior includes a first tapered surface.

6. A tube fitting for use in combination with a thick-walled tube as claimed in claim 5 wherein said exterior includes a second tapered surface.

7. A tube fitting for use in combination with a thick-walled tube as claimed in claim 2 wherein said exterior includes a first tapered surface.

8. A tube fitting for use in combination with a thick-walled tube as claimed in claim 7 wherein said exterior includes a second tapered surface.

9. A tube fitting for use in combination with a thick-walled tube as claimed in claim 3 wherein said exterior includes a first tapered surface.

10. A tube fitting for use in combination with a thick-walled tube as claimed in claim 9 wherein said exterior includes a second tapered surface.

11. A tube fitting for use in combination with a thick-walled tube as claimed in claim 2 wherein said sleeve has a longitudinal axis, said extended lip portion includes a recess, said recess includes first and second legs, and said first leg being parallel to said longitudinal axis and said second leg being substantially transverse to said first leg.

12. A tube fitting for use in combination with a thick-walled tube as claimed in claim 11 wherein said second leg and said first leg form an angle less than 90°.

13. A tube fitting for use in combination with a thick-walled tube and a connection body, comprising:
a sleeve in engagement with said thick-walled tube;
said sleeve being generally cylindrically shaped and having a coating thereover;
said sleeve includes a sharp annular biting portion engaging said thick walled tube;
said sleeve includes an inner annular symmetric concavity;
said concavity of said sleeve interengaging said thick-walled tube;
said thick-walled tube includes an end portion;
said end portion of said thick walled tube being flared;
a gland about said thick-walled tube engageable with said sleeve, said gland including exterior threads thereon;
a connection body;
said connection body includes a frusto-conical portion;
said connection body includes interior threads therein;
said exterior threads of said gland interengaging said interior threads of said connection body, coupling said tube, said tube fitting and said connection body together; and, said flared end of said thick-walled tube interengaging and sealing against said frusto-conical portion of said connection body.

14. A tube fitting for use in combination with a thick-walled tube as claimed in claim 13 wherein said exterior includes a first tapered surface.

15. A tube fitting for use in combination with a thick-walled tube as claimed in claim 14 wherein said exterior includes a second tapered surface.

16. A tube fitting for use in combination with said thick-walled tube and a connection body as claimed in claim 13, wherein said connection body further includes an exterior and a leak detection passageway extending to said exterior of said connection body.

17. A tube fitting for use in combination with a thick-walled tube as claimed in claim 1 wherein said coating is XADC-Armoloy®.

18. A tube fitting for use in combination with a thick-walled tube as claimed in claim 1 wherein said coating is XADC-Armoloy® and is 0.0003-0.0006 inches thick.

19. A process for making a tube fitting for use in combination with a thick-walled tube comprising the steps of:
placing an end portion of a thick-walled tube into engagement with a tube engaging surface of a frusto-conical portion of a die such that the inner diameter of said tube interengages said tube engaging surface of said frusto-conical portion of said die, said die supported by a driving piston;
sliding a sleeve over said tube, said sleeve includes an interior and an exterior, said exterior of said sleeve being having a coating thereover, said sleeve includes a sharp annular biting portion engaging said thick-walled tube, said sleeve includes an interior concavity, said concavity of said sleeve interengaging said thick-walled tube after deformation of said tube and said sleeve;
securing said sleeve into forceful engagement with said die;
driving said die into said thick-walled tube and said sleeve with said driving piston;
flaring said end portion of said thick-walled tube; and, deforming said sleeve into engagement with said thick-walled tube.

20. A process for making a tube fitting for use in combination with a thick-walled tube as claimed in claim 19 wherein said coating on said sleeve is an XADC-Armoloy® coating.

21. A process for making a tube fitting for use in combination with a thick-walled tube as claimed in claim 19 wherein said sliding sleeve has a longitudinal axis, said extended lip portion includes a recess, said recess includes first and second legs, and said first leg being parallel to said longitudinal axis and said second leg being substantially transverse to said first leg, and said step of driving said die into said thick-walled tube includes forcing and engaging said sharp annular biting portion with said thick-walled tube deforming said tube into engagement with said recess in said extended lip.

22. A process for making a tube fitting for use in combination with a thick-walled tube as claimed in claim 19 wherein said coating on said exterior of said sleeve is etched.

23. A tube fitting for use in combination with a thick-walled tube as claimed in claim 1 wherein said coating on said exterior of said sleeve is etched.
